(19) United States
(12) Patent Application Publication
(10) Pub. No.: US 2023/0131682 A1
(43) Pub. Date: Apr. 27, 2023

(54) FACILITATED LIVE ANALYSIS OF SCREEN CONTENT

(71) Applicant: Citrix Systems, Inc., Ft. Lauderdale, FL (US)

(72) Inventor: Manbinder Pal Singh, Coral Springs, FL (US)

(73) Assignee: Citrix Systems, Inc., Ft. Lauderdale, FL (US)

(21) Appl. No.: 17/509,720

(22) Filed: Oct. 25, 2021

(51) Int. Cl. G06K 9/00; G06F 9/451

(52) U.S. Cl. CPC G06K 9/00442; G06F 9/451

(57) ABSTRACT

A computer system is provided. The computer system includes a memory and at least one processor coupled to the memory. The at least one processor is configured to implement a rule processor to receive a UI element recognition rule comprising one or more UI element specifications and a response action from a workspace server, and generate a task identifier for the received UI element recognition rule; implement a computer vision (CV) processor to receive the task identifier from the rule processor, and recognize, based on the one or more UI element specifications and the task identifier, a UI element presented at the client computer system; and implement an action handler configured to execute the response action based on the task identifier and in response to the recognized UI element.

### BACKGROUND

Software support systems provide tools that enable end users and support personnel to collaborate to find workarounds or other resolutions to system errors encountered by end users. For example, some software support systems provide end users with searchable support articles through which the users can find resolutions to many common problems. Other software support systems enable end users or support personnel to open tickets to document and manage each supportable incident reported by an end user. These tickets remain open until the incident associated with the ticket is resolved. Further some software support systems utilize tickets to provide both end users and support personnel with information regarding the status of the incident and to drive support workflow. Further still, some types of software support systems enable support personnel such as information technology (IT) administrators to review and/or control a computer system associated with the end user for diagnostic purposes. Collectively, these software support systems provide the end user and support personnel with an effective set of tools upon which to rely when troubleshooting system errors.

As such tickets are opened or new errors become apparent, the IT administrators may wish to respond to new errors in a timely manner, as appropriate to the scale and incidence of the new errors. Likewise, administrators may also wish to be made aware of events that affect end users' productivity, privacy, security, or risk level.

### SUMMARY

In at least one example, a client computer system is provided. The client computer system includes a memory and at least one processor coupled to the memory. The at least one processor is configured to receive a recognition rule comprising one or more UI element specifications and a response action from a server. The at least one processor is further configured to generate a task identifier corresponding to the received recognition rule and associate the task identifier with the recognition rule. The at least one processor is further configured to recognize, based on the one or more UI element specifications of the recognition rule and the task identifier, a UI element rendered at the client computer system. The at least one processor is further configured to execute, in response to the recognition of the UI element, the response action of the recognition rule based on the task identifier.

At least some examples of the client computer system can include one or more of the following features. In the system, to recognize the UI element based on the recognition rule can further comprise to execute a CV process.

In the system, to execute the CV process can further comprise one or more of: to identify a rectangle; to filter out a user interface (UI) element; to identify a detail of a dialog or menu item group; or to classify a rectangle using a guided heuristic.

In the system, to recognize the UI element based on the recognition rule can further comprise to execute a machine learning (ML) process.

In the system, the at least one processor can be further configured to: generate a numerical hash value by executing a hash function on one or more characteristics of the rendered UI element; and send the numerical hash value to the server. The system can further comprise the server. The server can be configured to track a number of instances of the numerical hash value.

In the system, the one or more UI element specifications can describe one or more of: a size or shape of a dialog or window; text of a dialog or window; an icon or image of a dialog or window; a progress bar or scroll bar of a dialog or window; a button or other control of a dialog or window; a menu item; or a number of instances or affected users associated with the UI element.

In the system, the recognition rule can comprise a structured recognition rule tag including: one or more structured UI element specification tags encoding the one or more UI element specifications; and a structured response action tag encoding the response action.

In the system, the UI element rendered at the client computer system can comprise one or more of: an error notification; a password entry field; a delay notifier; a pop-up menu item; personal information; or a personal message.

In at least one example, a method of recognizing and responding to user interface (UI) elements is provided. The method includes acts of receiving a recognition rule comprising one or more UI element specifications and a response action from a server; recognizing, based on the one or more UI element specifications, a UI element rendered at the client computer; and executing, in response to the recognition of the UI element, the response action of the received recognition rule.

At least some examples of the method can include one or more of the following features. The method can further include acts of executing a CV process to recognize the UI element based on the recognition rule, wherein the CV process comprises one or more of: identifying a rectangle; filtering out a user interface (UI) element; identifying a detail of a dialog or menu item group; or classifying a rectangle using a guided heuristic.

The method can further include an act of executing a machine learning (ML) process to recognize the UI element based on the recognition rule.

The method can further include acts of generating a numerical hash value by executing a hash function on one or more characteristics of the rendered UI element; sending the numerical hash value to the server; and tracking, by the server, a number of instances of the numerical hash value.

The one or more UI element specifications can describe one or more of: a size or shape of a dialog or window; text of a dialog or window; an icon or image of a dialog or window; a progress bar or scroll bar of a dialog or window; a button or other control of a dialog or window; a menu item; or a number of instances or affected users associated with the UI element.

The recognition rule can comprise a structured recognition rule tag including: one or more structured UI element specification tags encoding the one or more UI element specifications; and a structured response action tag encoding the response action.

At least some examples are directed to a non-transitory computer readable medium storing executable instructions to recognize and respond to user interface (UI) elements. In these examples, the instructions can be encoded to execute any of the acts of the method of recognizing and responding to UI elements described above.

At least some examples are directed to a server system. The server system can include a memory and at least one processor coupled to the memory. The at least one processor can be configured to receive configuration input specifying a UI element recognition rule, the UI element recognition rule comprising one or more UI element specifications and a response action; and send the UI element recognition rule to a client computer configured to implement a rule processor, a computer vision (CV) processor, and an action handler. The rule processor can be configured to: receive the UI element recognition rule; and generate a task identifier corresponding to the recognition rule. The CV processor can be configured to: receive the task identifier; and recognize, based on the one or more UI element specifications, a UI element. The action handler can be configured to execute the response action based on the task identifier and in response to the recognized UI element.

At least some examples of the server system can include one or more of the following features. In the server system, to recognize the UI element can comprise to implement CV for one or more of: to identify a rectangle; to filter out a user interface (UI) element; to identify a detail of a UI element; or to classify a rectangle using a guided heuristic.

In the server system, the processor can be further configured to: receive a numerical hash value from the client computer, wherein the client computer can be configured to generate the numerical hash value by executing a hash function on one or more characteristics of the UI element; and track a number of instances of the numerical hash value.

In the server system, the one or more UI element specifications can describe one or more of: a size of a dialog or window; a shape of a dialog or window; an aspect ratio of a dialog or window; title text of a dialog or window; button text of a dialog or window; display text of a dialog or window; an icon or image of a dialog or window; a progress bar or scroll bar of a dialog or window; a number or configuration of buttons of a dialog or window; another control of a dialog or window; menu item text; an arrangement of menu items; a number of instances associated with the UI element; or a number of affected users.

In the server system, to recognize the UI element can comprise to recognize one or more of: an error notification; a password entry field; a delay notifier; a pop-up menu item; personal information; or a personal message.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of an error remediation (ER) system in accordance with an example of the present disclosure.

FIG. 2 illustrates an example warning presented to a user during a workspace session.

FIG. 3 illustrates an example password entry dialog box presented in a workspace session for a user.

FIG. 4 is a block diagram of a user interface (UI) monitor in accordance with an example of the present disclosure.

FIG. 5 illustrates an example dialog box being recognized via a computer vision (CV) process in accordance with an example of the present disclosure.

FIG. 6 illustrates an example of menu items being recognized via a CV process in accordance with an example of the present disclosure.

FIG. 7 illustrates an example of windows being recognized via a machine learning (ML) process in accordance with an example of the present disclosure.

FIG. 8 is a block diagram of a network environment of computing devices in which various aspects of the present disclosure can be implemented.

FIG. 9 is a block diagram of a computing device that can implement one or more of the computing devices of FIG. 8 in accordance with an example of the present disclosure.

FIG. 10 is a block diagram of the ER system of FIG. 1 as implemented by a specific configuration of computing devices in accordance with an example of the present disclosure.

FIG. 11 is a block diagram of the ER system of FIG. 1 as implemented by a specific configuration of computing devices in accordance with an example of the present disclosure.

FIG. 12 is a block diagram of a system configured to recognize and respond to UI elements, as implemented by a specific configuration of computing devices in accordance with an example of the present disclosure.

FIG. 13 is a block diagram of the ER system of FIG. 1 as implemented by a specific configuration of computing devices in accordance with an example of the present disclosure.

FIG. 14 is a block diagram of the ER system of FIG. 1 as implemented by a specific configuration of computing devices in accordance with an example of the present disclosure.

FIG. 15 is a block diagram of the ER system of FIG. 1 as implemented by a specific configuration of computing devices in accordance with an example of the present disclosure.

FIG. 16 is a flow diagram of an ER process in accordance with an example of the present disclosure.

FIG. 17 is a front view of a screen provided by a triage interface in accordance with an example of the present disclosure.

FIG. 18 is a flow diagram illustrating a triage process in accordance with an example of the present disclosure.

FIG. 19 is a front view of a screen provided by a monitored application and the ER system of FIG. 1 in accordance with an example of the present disclosure.

FIG. 20 is a front view of a screen provided by a monitored application and the ER system of FIG. 1 in accordance with an example of the present disclosure.

FIG. 21 is a block diagram of a session triage system in accordance with an example of the present disclosure.

FIG. 22 is a block diagram of an error detection service in accordance with an example of the present disclosure.

FIG. 23 is a block diagram of the session triage system of FIG. 27 as implemented by a specific configuration of computing devices in accordance with an example of the present disclosure.

FIG. 24 is a flow diagram of a session triage process in accordance with an example of the present disclosure.

FIG. 25 is a front view of a screen provided by a session triage interface in accordance with an example of the present disclosure.

FIG. 26 is a flow diagram of a session triage process in accordance with an example of the present disclosure.

FIG. 27 is a flow diagram of a recording playback process in accordance with an example of the present disclosure.

FIG. 28 is a flow diagram of a summarization process in accordance with an example of the present disclosure.

FIG. 29 is a flow diagram of a process for recognizing and responding to UI elements in accordance with an example of the present disclosure.

FIG. 30 is a flow diagram of a process for processing rules while recognizing and responding to UI elements in accordance with an example of the present disclosure.

FIG. 31 is a flow diagram of a process for processing CV while recognizing and responding to UI elements in accordance with an example of the present disclosure.

FIG. 32 is a flow diagram showing details of a process for recognizing UI elements in accordance with an example of the present disclosure.

FIG. 33 is a flow diagram of a process for handling actions while recognizing and responding to UI elements in accordance with an example of the present disclosure.

FIG. 34 is a schematic diagram of a full session recording and a summary thereof in accordance with an example of the present disclosure.

FIG. 35 is a block diagram of the session triage system of FIG. 27 as implemented by a specific configuration of computing devices in accordance with an example of the present disclosure.

### DETAILED DESCRIPTION

As summarized above, various examples described herein are directed to session triage and error remediation systems and methods for use with computing devices. These systems and methods overcome technical difficulties that arise when errors are encountered, for example, in a monitored application that requires a patch, upgrade, or change in configuration, but support personnel are unable to perform the required activity. In these situations, support personnel may be unable to fix the root cause of the error but are still tasked with supporting end users who encounter the error.

To address this issue, some support personnel send emails or other sorts of messages to end users who may be affected by a given error and/or other users as a precautionary measure. But this approach is unsatisfactory in that the end users must still endure the error. Often, despite the email sent by the support personnel, the end users respond to errors by opening tickets to be serviced by the support personnel, especially where a resolution or workaround is difficult for the end user to perform. This end user behavior can be particularly troublesome where a single incident causes an error that effects a large number of users. In these situations, a large volume of tickets may be opened, thus forcing support personnel to triage multiple instances of the same issue, which results in a large amount of redundant and duplicated effort.

This redundant effort can be further exacerbated where the errors are difficult to triage. In these situations, support personnel may enable session recording and/or tracing in an attempt to capture errors within their operational contexts. However, due to the amount of contextual information they contain, session recordings and trace logs can be burdensome to navigate. As such, the widespread use of session recording and/or tracing can produce a negative compounding effect on a support organization's ability to serve its end users.

Thus, and in accordance with at least some examples disclosed herein, session triage and error remediation systems and methods are provided. These systems and methods provide for detection of errors and other supportable events encountered by end users and present the errors and events to support personnel for triage. In some examples, a session triage system detects an error message present within live or prerecorded session data, generates an error signature unique to the error message, determines whether an error with the signature has been previously triaged, and provides a triage interface that navigates the session data to points where untriaged error messages are located. In these examples, the triage interface receives input from support personnel specifying remediations for the errors and stores the remediations in association with the signatures, so that future instances of the error can be automatically remediated. In addition, within these examples, the triage interface automatically maintains the triage status of events presented within other session recordings based on remediations specified for successfully triaged errors. In this way, the session triage systems and methods described herein automatically triage these other session recordings, relieving support personnel from the need to re-triage duplicate errors in these other session recordings.

The system and methods disclosed herein further provide for on-the-fly remediation of errors associated with error messages in a variety of monitored software applications, such as web applications, software as a service (SaaS) applications, virtual applications, and local applications (e.g., Windows® applications). In some examples, an error remediation system detects an error message, generates an error signature unique to the error message, matches the signature to a signature stored in an error record that documents a previously triaged and remediated instance of the error message, fetches a remediation stored in the record, and provides the remediation to the end user. Further, in some examples, the error remediation system provides a user interface to support personnel that enables the support personnel to identify error messages being encountered by end users, triage the error messages to select error messages with the most impact on the end users, and define remediations for the selected error messages. Remediations defined by the support personnel via this triage user interface are stored within error records documenting the error message and its remediation, thereby enabling the error remediation system to provide the remediation to end users who encounter the error message in the future.

As will be understood in view of this disclosure, the error remediation systems and methods provided herein have several advantages over other support automation. For instance, the error remediation systems and methods described herein enable automatic and immediate remediations for error messages without requiring modifications to a monitored application. This can be particularly helpful where the monitored application cannot be modified by the support personnel. Further, the error remediation systems and methods described herein enable support personnel to identify, triage, and remediate errors based on, for example, the number of users effected and/or the severity of the error message. In addition, once a remediation to an error message is established, that remediation is automatically provided to all users who encounter the error message. This can help prevent end users from repetitively encountering, and potentially opening tickets for, the same issues without some form of remediation being provided. Similarly, once an error present within a session recording is triaged, other session recordings including the error are automatically triaged. This helps prevent support personnel from investing duplicative effort manually triaging the errors. Further, by automatically navigating session recordings, the systems and method described herein eliminate manual errors that sometimes accompany manual triaging of session data.

Through these features, the session triage and error remediation system and methods described herein magnify the positive impact support personnel can provide to the end users they support. Moreover, the error remediation systems and method described herein enable the development or support personnel to input remediations to errors discovered during final regression testing of a release, thereby decreasing the support calls after the release is in production. These and other advantages will be recognized in view of this disclosure.

In another aspect of this disclosure, the system can address limitations and challenges in some methods to detect UI controls using UI automation application programming interfaces (APIs). In particular, UI automation APIs may not work for applications and controls that do not support automation, for example a browser with custom controls. Similarly, some operating systems (OSs), such as Mac OS, may not allow automation. Moreover, automation can incur a performance overhead, since available server density is decreased if hooks and APIs are used on the side of the virtual delivery agent (VDA). In addition, protocol changes may be required to enable sending information between the VDA and client device. By contrast, some of the ML methods disclosed herein can operate on the client side within a browser, accordingly requiring no client-side or VDA-side changes.

In addition, the system can address limitations and challenges in some methods to detect UI controls within session recordings. For example, UI automation and hooks may not help to detect custom dialogs or UI elements, for example, browser dialogs. Moreover, because analysis of session recordings occurs subsequent to the user session, the administrator is unable to mitigate the event or interact with the user at the time the event occurs. For example, a security event must be managed proactively rather than after the event. Likewise, in the case of an error dialog or productivity loss (e.g., a delay symbol such as a spinning wheel being encountered by many users), administrators would like to be notified immediately so that they can mitigate the issue in real time. In another example, session recording cannot help reduce the number of users who open multiple tickets for the same error dialog, as users would have already filed the ticket before the administrator reviews the recordings. Finally, an administrator cannot interact proactively with a session recording to, for example, provide remediations and updates to the users.

Other limitations and challenges addressed by examples disclosed herein include server-side analysis of screen content, which incurs cloud cost and leaves less server and/or graphics processing unit (GPU) density available to run user sessions on a host virtual machine (VM). In yet another example, using conventional systems, such as systems that analyze errors based on session recordings, administrators lack the ability to set a rule that if a particular error or warning occurs a number of times across a number of user sessions, the system should take a specific action. Finally, since session recorders have no microapp integration, systems that utilize session recordings may be unable to take action via microapp to send a notification to an administrator and/or a security operations center (SOC) team in response to a security or authorization event. The disclosed system and methods can address these and other needs.

In certain examples, an error remediation system as disclosed herein operates on data descriptive of UI elements displayed or to be displayed within the UI of a computer system. For instance, in some examples, the error remediation system detects error messages by monitoring UI elements displayed, or to be displayed, in the UI; identifying changes in the UI elements; and executing a classifier in response to identifying changes in the UI elements. These UI elements can be provided by one or more monitored applications. In some examples, the classifier determines whether the UI, including the changed UI elements, depicts an error message. In these examples, the error remediation system can execute detection operations by processing a wide variety of UI data. Examples of this UI data include hypertext markup language (HTML) descriptive of the UI elements, UI automation messages descriptive of the UI elements, hook messages descriptive of the UI elements, and image data depicting rendered UI elements. The HTML descriptive of the UI elements can be organized within, for example, a document object model (DOM).

The error message detection processes that operate on the UI data can be housed within various components of the error remediation system. For instance, in some examples, these detection processes are housed within a browser plugin or extension. In these examples, the detection processes operate on HTML data to execute the detection operations described herein. For instance, the detection process can scan a DOM including the HTML data. In other examples, the error message detection processes are housed within a browser itself, and thus no plugin or extension is required. In these examples, the error message detection processes operate on HTML data to execute the detection operations described herein. It should be noted that the browser or browser plugin can be executed by a virtual machine hosted by a physical server.

In other examples, the error message detection processes are housed within an application executed by an intermediate device (e.g., an application delivery controller (ADC)) disposed between an application server and an application client. In these examples, the error message detection processes operate on HTML data and/or image data passing between the client application and the server application. In other examples, the error message detection processes are housed within a local process supported by an operating system of a client device that also renders the UI. This local process can execute in the background as an independent process, can execute as part of a virtualization service, and/or can execute as a part of the monitored application that generates the UI. In these examples, the error message detection processes can operate on UI automation messages, hook messages, HTML and/or other UI data generated by the monitored application.

A variety of classifiers can be used to detect error messages within UI data. For instance, in some examples, the error remediation system executes a classifier that scans the UI data, or data derived from the UI data, for keywords associated with error messages. This derived data can include text data output from an optical character recognition (OCR) and/or computer vision (CV) processes. In other examples, the classifier executes a machine learning (ML) process that operates on input including the UI data and/or data derived from the UI data. In these examples, the ML process can be trained to recognize text and/or objects commonly displayed at particular locations when an error message is encountered. In some examples, the error remediation system executes a single classifier for all changes in UI elements. In other examples, the error remediation system executes one or more classifiers that are tailored to specific types of monitored applications.

In some examples, the error remediation system forms, in response to detecting an error message, a signature uniquely identifying the error message. The attributes of a signature can vary between examples and/or types of monitored applications. For instance, where the UI data is HTML data, the signature can include a UI hierarchy derived from a DOM including the HTML data. This UI hierarchy can include a root object and a line of descendant objects that terminates in an object storing the error message. Similarly, where the UI data are UI automation messages and/or hook messages, the signature can include a UI hierarchy that includes a root automation or hook element and a line of descendant automation or hook elements that terminates in an automation or hook element representing the error message.

In certain examples, a signature can include other attributes. For instance, in some examples, the attributes of a signature can include identifiers such as a title, universal resource locator (URL), or host for a page served by a monitored web or SaaS application. Alternatively or additionally, a signature can include a title of window or dialog provided by a local monitored application or a process name associated with the local monitored application. A signature can also include metadata descriptive of the error message, as described further below.

In some examples, the error remediation system provides on-the-fly remediations to previously identified and triaged error messages as and when the error messages are encountered by end users. For instance, in certain examples, the error remediation system uses the signature of an error message encountered by an end user to identify a remediation for the error message. For example, the error remediation system can search for and find an error record that includes the signature and a remediation for the error identified by the signature. In some examples, the error remediation system immediately overlays the error message with a remediation message stored in the identified error record. Alternatively or additionally, the error remediation system can provide the remediation message adjacent to the error message or in a window distinct from the error message. The remediation message can include text describing a work around, including a link to additional resources regarding the error message, etc. Further, in some examples, the error remediation system matches visual characteristics (colors, font, duration, style, etc.) of a remediation message to the overall theme of the UI. It should be noted that the error remediation system can provide remediations without requiring any changes to the application generating the error message being remediated.

In other examples where the error remediation system is capable of modifying the monitored application, the identified remediation may include a link to an installable package. In these examples, the error remediation system can apply the installable package to the monitored application to remediate the error message. The installable package can include, for example, a patch build with changes to the monitored application and/or information to reconfigure the settings of the monitored application.

In some examples, the error remediation system provides a UI that enables support personnel to triage and remediate errors encountered by end users. For instance, in some examples, this triage interface tabulates and provides counts and frequencies of error messages grouped by monitored application, customers, regions, sites, etc. In these examples, the triage interface interacts with support personnel to receive input descriptive of remediations. In response to receiving such input, the triage interface stores the remediations in error records that associate the remediations with signatures of errors messages to which the remediations apply. Further, in some examples, the triage interface interacts with support personnel to maintain (update and/or rollback) the classifier used to detect error messages. It should be noted that users of the triage interface can include support personnel (e.g., information technology administrators) employed by the same business organization as the end users and/or support personnel employed by a service provider distinct from the employer of the end users. Thus, the triage interface can be widely utilized to the benefit of end users.

The error remediation system can provide the triage interface via a variety of implementation techniques, such as by serving the triage interface via a web server and/or by incorporating and interoperating with a local application. In some examples, the error remediation system exposes an application program interface (API) through which it provides the triage interface. In some examples, the error remediation system hosts the triage interface processes described herein on a server distinct from the other processes executed by the error remediation system. Other implementation techniques for the triage interface will be apparent in view of this disclosure.

In certain examples, a session triage system as disclosed herein operates on session data descriptive of UI elements displayed during an interactive computing session. This interactive computing session can involve communications between a user and a client computer and communications between the client computer and a server computer. In some examples, the session triage system scans the session data to detect changes in UI elements and classifies each detected change as either depicting or not depicting an error message. If the change depicts an error message the session triage system stores an association between the error message and a point in the session data where error message is present. The session triage system later provides access to this point in the session data via a UI that references the association. By providing this UI, some examples of the triage system enable support personnel to more easily navigate session recordings including the session data.

In some examples, the session triage system classifies the changes in the UI elements as depicting or not depicting an error message by executing a keyword search on text extracted from image data included in the UI elements. In other examples, the session triage system classifies changes in the UI elements as depicting or not depicting an error message by executing a ML process, such as a CV process, on image data included within the UI elements. In various examples, the system can apply CV and/or ML to recognize UI elements that satisfy a rule condition, and can then execute an action in response to the rule condition.

In some examples, the session triage system generates a summary of session data included within session recordings. This summary can include images of error messages, screenshots including the error message, and session data surrounding the point in the session data where the error message is present. Thus, the summary can include a plurality of images to provide support personnel with additional context for the error message.

In some examples, the session triage system records trace data concurrently with the session data. In these examples, the session triage system can insert error messages encountered within the session data into the trace data, thereby providing an indication within the trace data as to the location of additional diagnostic information surrounding occurrence of the error.

In some examples, the session triage system generates an error signatures and uses the error signatures to track occurrences of errors within session recordings. In these examples, the session triage system tabulates a plurality of metrics (e.g., counts, counts by user, counts by business organization, etc.) descriptive of the occurrences of the errors. Further, in these examples, the session triage system provides a UI that displays the errors and the plurality of metrics that describe occurrences of the errors. The UI can receive input from support personnel specifying remediations for the errors. In some examples, the session triage system automatically triages session recordings including the error for which remediations are supplied, thereby preventing support personnel from wasting time reviewing already triaged errors within other session recordings.

It should be noted that users of the session triage interface can include support personnel (e.g., information technology administrators) employed by the same business organization as the end users and/or support personnel employed by a service provider distinct from the employer of the end users. Thus, the triage interface can be widely utilized to the benefit of end users.

The session triage system can provide the triage interface via a variety of implementation techniques, such as by serving the triage interface via a web server and/or by incorporating and interoperating with a local application. In some examples, the session triage system exposes an application program interface (API) through which it provides the triage interface. In some examples, the session triage system hosts the triage interface processes described herein on a server distinct from the other processes executed by the session triage system. Other implementation techniques for the triage interface will be apparent in view of this disclosure.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### Error Remediation System

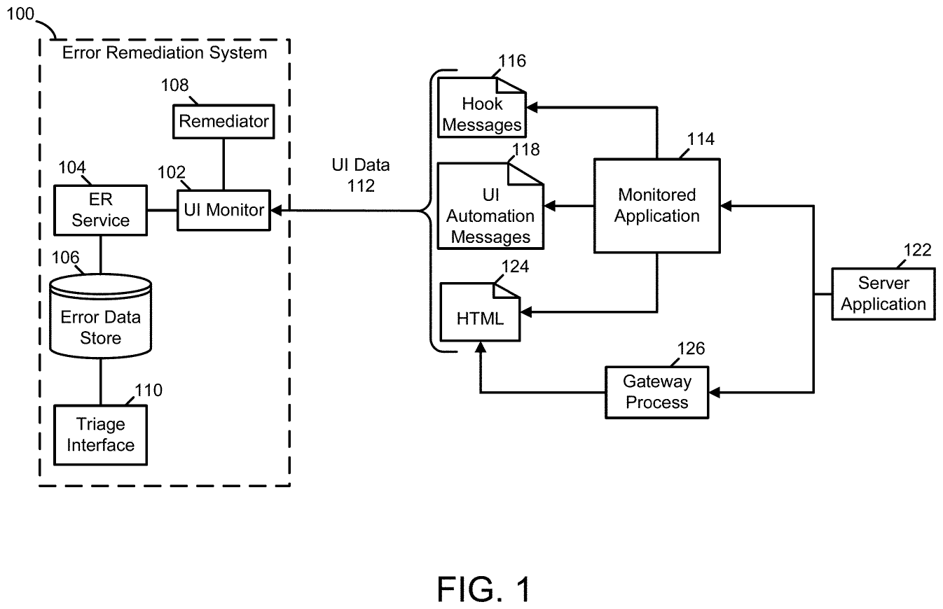

In some examples, an error remediation system is configured to identify and timely remediate error messages generated by monitored applications. These monitored applications can include any process capable of displaying information within the UI of a client device, such as locally executed applications, web applications, SaaS applications, and the like. FIG. 1 illustrates a logical architecture of an error remediation system 100 in accordance with some examples. As shown in FIG. 1, the system 100 includes a UI monitor 102, an ER service 104, an error data store 106, a remediator 108, and a triage interface 110.

FIG. 1 further illustrates types of UI data 112 that can be processed by the UI monitor 102 and components that generate the data 112. As shown, the data 112 can include one or more of hook messages 116, UI automation message 118, and/or HTML 124. The hook messages 116 and UI automation messages 118 are generated from UI related processes executed by a monitored application 114. The HTML 124 originates from a server application 122 and is served to the monitored application 114. In some examples, the HTML 124 is transmitted to the monitor 102 from the server 122 via a gateway process 126 before the HTML 124 is received by the monitored application 114. In other examples, the HTML 124 is transmitted to the monitor 102 by the monitored application 114 after it is received by the monitored application 114.

In some examples, the monitor 102 is configured to receive and process one or more of the hook messages 116, the automation messages 118, and the HTML 124. In other examples, the monitor 102 is configured to process two or more of types of the data 112. In either case, the monitor 102 can be configured to acquire the data 112 using a variety of techniques. For instance, in some examples, the monitor 102 is configured to periodically poll sources (e.g., the monitored application 114, the server application 122, and/or the gateway process 126) of the data 112. In other examples, the monitor 102 is configured to register, with the sources of the data 112, to receive notifications regarding changes to the UI of the monitored application 114.

In some examples, the monitor 102 is configured to identify the error messages within the UI by first identifying changes to the UI and then analyzing those changes to determine whether the changes include an error message. The processes that the monitor 102 is configured to execute to identify the changes to the UI depend on the type of UI data available. For instance, in some examples, the monitor 102 is configured to receive notifications that precisely identify changes to the UI of the monitored application 114. In these examples, to identify the changes to the UI, the monitor 102 is configured to simply parse the notifications and store data descriptive of the changes in memory for subsequent processing.

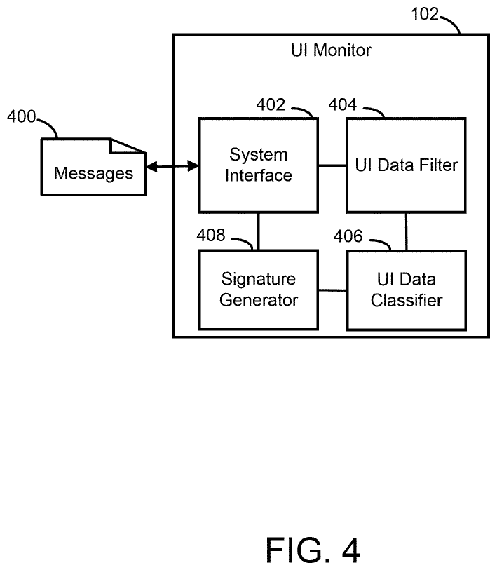

In other examples, the monitor 102 is configured to construct and/or inspect a time sequence of representations of the UI of the monitored application 114. In these examples, the monitor 102 is configured to identify the changes to the UI by contrasting consecutive representations in the time sequence and recording differences between the consecutive representations. These differences can include elements within a first representation of the UI that have no corresponding elements within a second representation of the UI. The differences can also include elements within the first representation that have corresponding elements within the second representation where the elements and the corresponding elements have differing attributes. As discussed in more detail below with reference to FIG. 4, these representations can include DOMs or representations constructed from UI automation or hook messages.

In some examples, the monitor 102 is configured to determine whether any identified changes to the UI include error messages by executing a classifier. This classifier can be configured according to any of a variety of classification techniques. For instance, in some examples, the monitor 102 is configured to execute a classifier that searches the identified changes for one or more keywords associated with error messages within a user-configurable dictionary. Examples of words that can be included in this dictionary include “failure,” “exception,” “error,” “terminated,” “denied,” “fatal,” and the like. In some examples, the monitor 102 is configured to periodically update the user-configurable dictionary with synonyms via a cloud service API, such as the Thesaurus API. Further, in some examples, the monitor 102 is configured to expose the user-configurable dictionary as a service endpoint. In some examples, the monitor 102 is configured to label an identified change as including an error message where the identified change includes a text value matching a word from the dictionary. Alternatively or additionally, where the identified changes include image data, the monitor 102 can be further configured to execute a classifier that inspects identified changes using OCR and/or CV techniques. In these examples, the classifier can be trained to identify text and/or icons within images that are commonly presented in error messages.

In some examples, the monitor 102 is configured to generate a signature that can be used to identify future instances of an error message. In these examples, a signature includes a subset of the representation of the UI of the monitored application 114. For instance, in one example, a signature includes a subset of the representation that begins with a root element and that continues through a line of descendants from the root element to an element identified as an error message. For instance, in one example, a signature includes a set of identifiers comprising an identifier of the monitored application 114, an identifier of a window or page in which the error message is displayed, an identifier of the main process that generated the error message, an identifier of the element in the representation corresponding to the error message, and/or metadata descriptive of the error (e.g., error code, stack trace, process name, business organization, region, etc.).

To illustrate, in one example, the monitored application 114 can be a web application (A1) that executes a main process (P1) that has a main window (W1) with several UI elements (E1, E2, and E3). Within this context, A1 can display an error message within a new window (W2) containing several new UI elements (E4, E5, and E6). Assuming E6 is the error message, the signature can include a UI hierarchy such as A1->P1->W2->E6. Alternatively or additionally, A1 can display an error message within the W1 as element E3. The signature for this error message can include a UI hierarchy such as A1->P1->W1->E3.

In some examples, the monitor 102 is configured to interoperate with the service 104 to store signatures within error records or identify remediations associated with error messages. In these examples, to store signatures or retrieve remediations, the monitor 102 is configured to transmit requests to the service 104. These requests can include the signatures. Further, in these examples, the monitor 102 is configured to receive and process responses to the requests. To process the responses, the monitor 102 is configured to parse the responses to identify acknowledgments or remediations. The acknowledgements can indicate that the service 104 created error records for the signatures in the error data store 106. The remediations can be remediations retrieved by the service 104 from the error data store 106 using the signatures. In these examples, the monitor 102 is configured to transmit the remediations, in response to receiving the same, to the remediator 108.

In certain examples, the monitor 102 is configured to interoperate with the service 104 via one or more intermediate processes (e.g., a VDA in a virtualized environment). For instance, in some examples where the intermediate process is a VDA, the monitor 102 can be configured to interoperate with a VDA process hosted by the server computer hosting the monitor 102. In these examples, this server-hosted VDA process can communicate via a communication channel (e.g., a virtual channel) with another VDA process hosted by a client device where an end user is accessing a monitored application and the client-hosted VDA process can communicate with the service 104. This configuration can be particularly advantageous where the client device has sufficient connectivity to interoperate with the service 104, but the server computer does not.

In some examples, the data store 106 is organized to store error records. Each of these error records associates a signature with a remediation by storing an identifier of the signature and an identifier of the remediation within fields of the same record. The data store 106 is also configured to store other data elements associated with signatures and remediations, such as remediation messages and links, signature metadata, and identifiers of monitored applications associated with the error messages and remediations. In some examples, the identifiers of the monitored applications are stored separately from the signatures to enhance system performance.

In some examples, the service 104 is configured to receive and process requests from the monitor 102 to store signatures within error records or identify remediations from error records. In these examples, the service 104 is configured to parse the requests, identify signatures stored in the requests, and search the error data store 106 for error records including the signatures. In some examples, the service 104 is further configured to create error records in the error data store 106 where the service 104 is unable to identify existing error records storing the signatures. In some examples, the service is also configured to retrieve remediations from error records storing the signatures or increment a counter in an error record storing the signature by omitting a remediation. In any case, the service 104 is configured to transmit responses to the monitor 102. The responses can include either retrieved remediations or acknowledgements of the creation/modifications of error records without remediations.

In certain examples, the service 104 is configured to provide the monitor 102 with a local copy of the data store 106 so that the monitor 102 can expeditiously lookup remediations associated with the signatures it generates. In these examples, the service 104 can be configured to provide the local copy in response to a request received from the monitor 102 and/or to push the local copy to the monitor 102 during initialization of the error remediation system 100 or in response to an update of the data store 106. In other examples, the monitor 102 is configured to use a two-tiered approach in which the monitor 102 attempts of identify an error record storing a signature within a local copy of the data store 106 and transmits a request to the service 104 to lookup the signature where it fails to find the signature in the local copy of the data store 106.

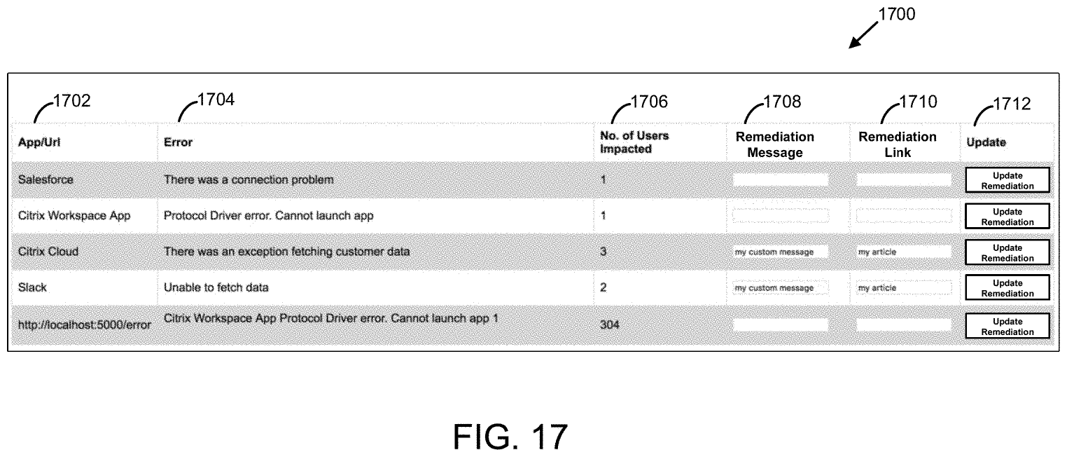

In some examples, the triage interface 110 is configured to provide a UI to interact with support users. This UI enables the support users to identify error messages being encountered by end users and specify remediations for the error messages. One example of a UI screen provided by the triage interface 110 is described further below with reference to FIG. 17.

In some examples, the remediator 108 is configured to receive and process requests from the monitor 102 to provide remediations to error messages. In these examples, the remediator 108 is configured to parse the requests, identify remediations stored in the requests, and apply the remediations. The remediator 108 can be configured to provide any of a variety of remediations to end users. For instance, in some examples, the remediator 108 is configured to deliver remediation messages stored in the remediations. These remediation messages can be displayed in conjunction with (e.g., adjacent to or overlaid upon) the error message. The remediation messages can instruct end users on a workaround for the error identified by the error message. These remediation messages can also include links that provide additional information on how to remediate the error. In other examples, the remediator 108 is configured to apply fixes stored in the remediations that resolve the error.

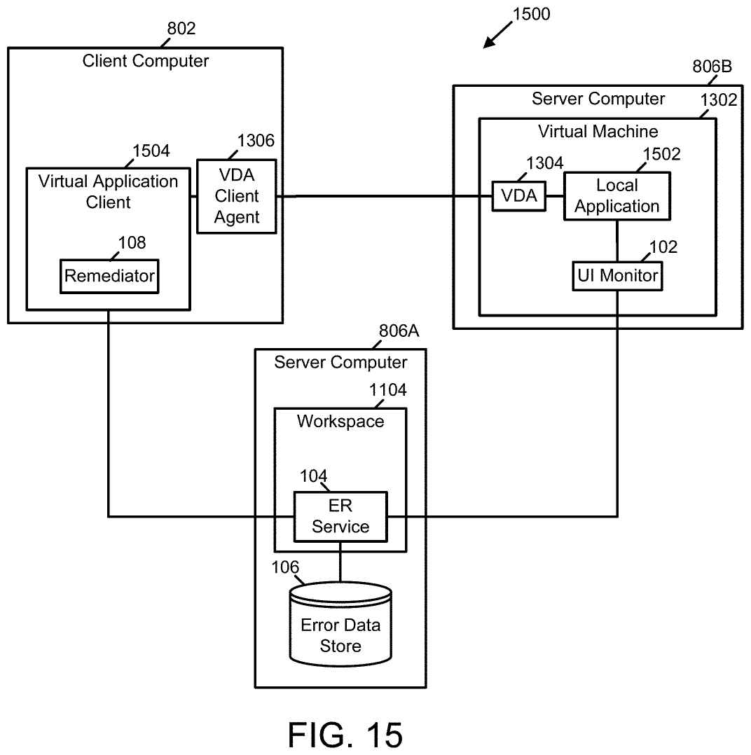

In some examples, the remediator 108 is configured to alter a DOM including an object representing an error message to include an object representing a remediation message. In at least one of these examples, the remediator 108 is configured to overlay the remediation message onto the error message using either DOM/shadow DOM API methods such as createElement, attachShadow, or the like on the root object of the DOM. In other examples, the remediator 108 is configured to provide the remediation message via other processes, which are described further below with reference to FIG. 15.

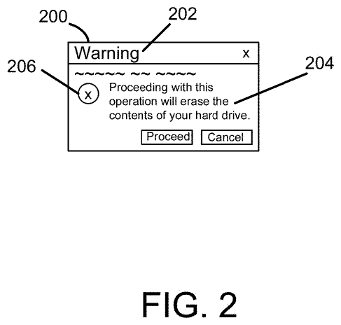

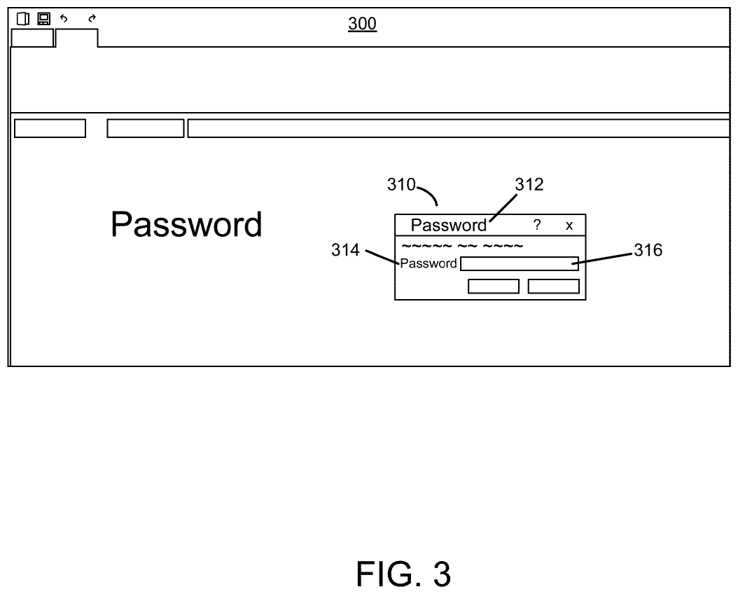

Accordingly, an administrator can use the disclosed system and methods to monitor user sessions and detect user activities, error messages, dialog boxes, or other UI elements that match rules set by the administrator. As discussed above and illustrated further in the examples of FIGS. 2, 19, and 20 below, the administrator can use this functionality for error remediation or troubleshooting applications. In addition, this monitoring functionality can be advantageous for various other use scenarios, as well. For example, the disclosed systems and methods enable the administrator to monitor presented UI elements and users' activities for use with applications relating to security, as illustrated in the example of FIG. 3 below, or to productivity, authorization, or privacy.

FIG. 2 illustrates an example error or warning UI element presented to a user during a workspace session. In this example, a user has made a selection to initiate an operation resulting in deleting the contents of the user's hard drive. For example, the user may have right-clicked on an icon representing the hard drive, and selected “Format . . . ” from a resulting pop-up menu, either intentionally or inadvertently. Accordingly, warning dialog 200 warns the user while confirming the user's selection.

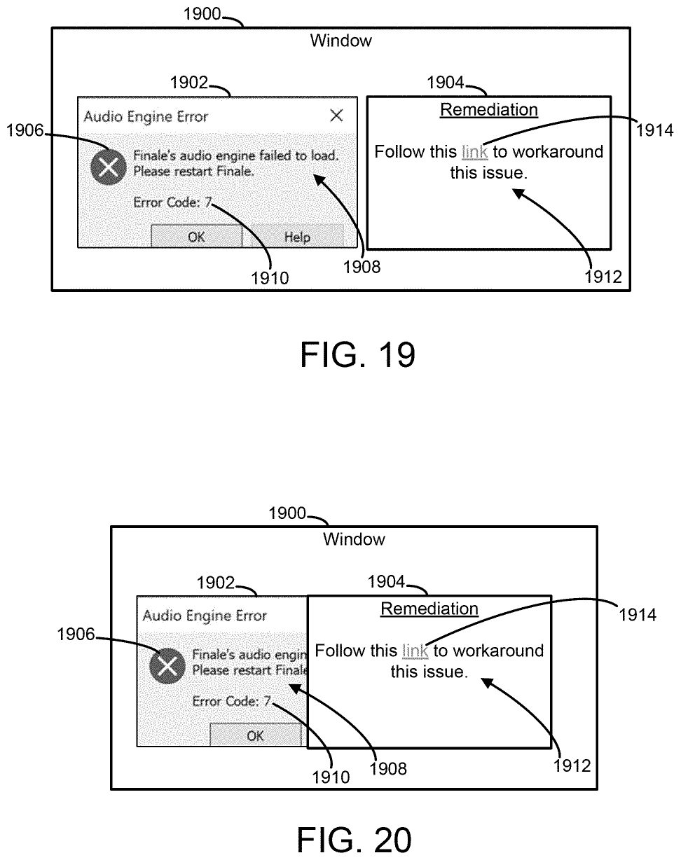

Warning dialog 200 includes title text 202, dialog message text 204, and icon 206. Multiple elements of warning dialog 200 may be used by the system to recognize warning dialog 200. For example, title text 202 reads “Warning,” message text 204 reads “Proceeding with this operation will erase the contents of your hard drive,” and icon 206 indicates a user warning. In some examples, an administrator can configure the system to recognize some or all of these elements, thereby detecting dialog 200 and triggering a rule. For example, the workspace server can send the administrator's configuration policies and/or rule to a client device, and the client device can initiate a job to identify matches to the rule condition, generate a task identifier (task ID) for the job, recognize UI elements matching one or more UI element specifications in the rule condition, optionally generate and send a hash code to the workspace server, and trigger and perform a rule action, as described herein below. In some examples, triggering the rule can also depend on a total number of instances of dialog 200 recognized across user sessions, a number of affected individual users, and/or a number of affected user sessions. The administrator can further configure the system to execute an action in response to recognized warning dialog 200, such as displaying a remediation dialog as in the examples of FIGS. 19 and 20.

FIGS. 19 and 20 illustrate a window 1900 presented by one example of the monitored application 114. As shown in FIG. 19, the window 1900 includes an error message dialog 1902 and one form of remediation provided by the remediator 108, a remediation dialog 1904. The error message dialog 1902 includes image data 1906, an error message 1908, and an error code 1910. The remediation dialog 1904 includes a remediation message 1912 and a remediation link 1914. The link 1914 provides access to an article describing a workaround to the error indicated by the error message 1908. As shown in FIG. 19, the remediation dialog 1904 is displayed adjacent to the error message dialog 1902. As shown in FIG. 20, the remediation dialog 1904 partially overlays the error message dialog 1902.

In some examples, the client device can execute a variety of rule actions that can be specified in a structured rule tag associated with a task ID active in the user session. For example, a structured rule tag (such as a Frame Processing Markup Language (FPML) tag) can specify characteristics of error message dialog 1902, and the system can recognize error message dialog 1902 when a task ID associated with the structured rule tag is active in the user session. In response to recognizing error message dialog 1902, the system can display remediation dialog 1904, or take any other action specified in the structured rule tag.

FIG. 3 illustrates an example password entry dialog box 310 presented in a workspace session for a user. For example, a user may be attempting to access a password protected file within an application 300, such as a password protected word processing document or other office document. In another example, the user may be logging into an account on an external website or accessing a secure internal network site via a browser. In this example, the administrator may wish to audit and monitor such password-protection or login processes for any problems or signs of inappropriate use. In a third example, the administrator may wish to detect a user trying to crack a password or log into an account without authorization, for example by making many repeated attempts to enter a password. Accordingly, the administrator may have a need to detect password entry instances automatically across different user sessions.

In the example of FIG. 3, password entry dialog 310 includes title text 312, which reads “Password,” password prompt 314, and password entry field 316. The administrator can configure the system to recognize these elements and trigger a rule. The workspace server can send the administrator's rule to a client device, and the client device can recognize password entry dialog 310 based on title text 312, password prompt 314, and/or password entry field 316, as specified in the rule condition. For example, the system can recognize password entry dialog 310 specifically, or can recognize password entry dialog 310 as an instance of password entry in general. Triggering the rule can also depend on a number of instances of password entry dialog 310 and/or a number of affected user sessions. The administrator can further configure the system to execute an action in response to recognized password entry dialog 310, such as recording video, keystrokes, or other information about the user session, alerting the administrator, or displaying a message or other information to the user. When the client device recognizes password entry dialog 310 and determines that the rule condition has been satisfied, it can then trigger the rule and execute the actions corresponding to the action portion of the rule.

The disclosed monitoring functionality can also be useful in other use scenarios besides error remediation and security applications. In a productivity application, the administrator may wish to monitor user sessions for productivity loss or for opportunities to improve efficiency. For example, a user may open an application or initiate an operation, but is kept waiting while the application or operation loads or sets up. In this example, the application or workspace session may display an icon or cursor denoting a user delay, such as a spinning wheel or hourglass. In this scenario, the administrator may wish to determine the total productivity loss associated with a spinning wheel detected for at least 90 seconds in a particular application, or even to determine how widespread this productivity loss pattern is across multiple users. Using the disclosed system and methods, the administrator can configure the system to detect the displayed delay icon or cursor. For example, the client device can hook into the API an application uses to set the cursor, use polling to query the cursor shape, or use CV and/or ML to determine that a delay icon or cursor is displayed. In another example, the client device can track a cumulative average delay for each application, or apply tests to quantify the statistical significance of the cumulative average delay.

In another application, an administrator may wish to monitor user attempts to initiate activities requiring authorization, in particular activities for which the user may lack the proper authorization. For example, a user may attempt to execute an application in privileged mode by right clicking the application's icon and selecting “Run as administrator” from a pop-up menu. In another example, a user may try to transfer a document or other file to an external device or an unauthorized cloud storage service, such as by right-clicking and selecting “Send to online drive” from a pop-up menu. For example, the system can use CV and/or ML determine menu item groups and menu items, and can use color attributes to determine “Run as administrator” is selected. In another example, the system can determine coordinates of the selected menu item, and can note a current mouse cursor click event near this menu item.

In still another application, the administrator may wish to protect users' privacy. For example, a user may load a website for a private user account, such as the user's personal email or social media account, which is not a corporate web or software-as-a-service (SaaS) app and thus should not be recorded in a session recording. In all these scenarios, the administrator can use the disclosed system and methods to monitor user sessions and recognize UI elements relevant to the respective error remediation, troubleshooting, security, productivity, authorization, and/or privacy applications, thereby triggering the appropriate rules. The disclosed system and methods can also be used for any other application, and are not limited by the present disclosure. For example, the workspace server can send the administrator's rule to a client device, and the client device can recognize UI elements matching the rule condition, optionally generate and send a hash code to the workspace server, and trigger and perform a rule action. In addition, the disclosed system and methods enable the administrator to configure these rules using only a small amount of high-level scripting, without the need to perform more extensive computer programming or develop or train ML models.

To enable processing of the various types of the data 112, the monitor 102 can implement a system interface through which the monitor 102 requests and/or receives the data 112 via any of a variety of messages. One example of such a system interface is shown in FIG. 4, which illustrates the logical architecture of the monitor 102 in accordance with some examples.

As shown in FIG. 4, the monitor 102 of FIG. 1 includes a system interface 402, a UI data filter 404, a UI data classifier 406, and a signature generator 408. In some examples, the system interface 402 is configured to interoperate with various components by exchanging messages 400 with the components. These components can include, for example, an ER service, a remediator, a monitored application and/or a gateway process (e.g., the ER service 104, the remediator 108, the monitored application 114, or the gateway process 126 of FIG. 1). The messages 400 can include the UI data (e.g., the data 112 of FIG. 1), signatures that identify error messages, and other data. The system interface 402 is configured to enable the monitor 102 to interoperate with these various components. As such, the system interface 402 may expose and implement an application program interface (API) and/or transmit and receive messages that conform with the APIs or interfaces of other components.

For instance, in some examples, the system interface 402 is configured to interoperate with a gateway process or a monitored application to request and receive HTML (e.g., the HTML 124 of FIG. 1), which constitutes a description of at least a portion of the UI of the monitored application. In other examples, the system interface 402 is configured to receive, from one or more operating system services, hook messages and/or UI automation messages (e.g., the hook messages 116 and/or the UI automation messages 118 of FIG. 1) descriptive of the operation of monitored application. Further, in some examples, the system interface 402 is configured to interoperate with the ER service by transmitting messages to the ER service that include signatures received from the signature generator 408.

In some examples, the filter 404 is configured to receive the UI data from the system interface 402 and determine whether the UI data includes changes from previously analyzed UI data. In these examples, the filter 404 is further configured to provide, where the UI data includes one or more changes, differences between the UI data and the previously analyzed data to the classifier 406.

The particular configuration of the filter 404 varies with the type of the UI data available to be processed. For instance, in certain examples, the UI data represents a complete screen of the UI of the monitored application. In these examples, the filter 404 is configured to maintain (e.g., in memory) a previous version of UI data to compare against a current version of the UI data to identify differences, which may represent error messages.

In one example, the filter 404 is configured to compare the HTML data to previously received HTML data to determine whether the HTML data includes one or more changed HTML elements. To facilitate comparison of the HTML data and the previously received HTML data, the HTML data can be received and/or stored in a first DOM and the previously received HTML data can be received and/or stored in a second DOM. To identify changed HTML elements, the filter 404 can be configured to scan each DOM from its root object downward and to generate a set of identified objects within the first DOM that have no corresponding object in the second DOM or that have a corresponding object with different attributes in the second DOM. This set of identified objects within the first DOM can represent the one or more changed UI elements.

In some examples, the filter 404 is further configured to remove identified objects that will not be reflected in the UI from the set of identified objects. For instance, in some examples, the filter 404 is configured to access the cascading styles sheets (CSS) attribute of identified objects and remove, from the set of identified objects, any identified objects for which the CSS attribute is set to “none.” In other examples, the filter 404 is further configured to call the window.getComputedStyle( ) function to determine whether any HTML elements within the DOM that are applied to an identified object would cause it to not be reflected in the UI. The filter 404 removes any such objects from the set of identified objects. In still other examples, the filter 404 is further configured to assess the zIndex property of identified objects and remove, from the set of identified objects, any members that would not be reflected in the UI due to obstructions caused by other objects. In certain examples, the filter 404 is further configured to provide the filtered set of identified objects to the classifier 406 for subsequent processing.

In another example, the filter 404 is configured to construct a current representation of the UI using the UI automation messages and/or the hook messages and to compare the current representation to a previously constructed representation. In some examples, the filter 404 interoperates with the UI automation and/or hook OS processes via the system interface 402 to construct the representations used for comparison purposes. More specifically, the filter 404 is configured to construct the representations by enumerating each automation or hook element of the UI and determining, via attributes of each element, whether the element is to be visibly rendered within the UI. Elements that are to be visibly rendered are included in a representation. Elements that are not to be visibly rendered are not included in the representation.

In this example, to identify changed automation or hook elements, the filter 404 can be configured to scan each representation from its root element downward and to generate a set of identified elements within the current representation that have no corresponding element in the previous representation or that have a corresponding element with different attributes in the previous representation. In some examples, the filter 404 is configured to provide the changed elements to the classifier 406 for further processing.

In some examples, the filter 404 is configured to receive, via the system interface 402, notifications that identify the changed DOM objects or automation/hook elements. In these examples, the processing executed by the filter 404 is minimal, as the changed objects or elements are identified within the notifications. To enable the filter 404 to receive notifications that identify the changed objects or elements, the filter 404 is configured to transmit a subscription request to the automation or hook process that monitors the monitored application and/or to the monitored application itself. For instance, in some examples where the monitored application is a browser or includes an embedded browser, the filter 404 is configured to interoperate with the browser via the MutationObserver Web API to subscribe to notifications regarding DOM events. The MutationObserver Web API can provide a set of events together, which allows the filter 404 to operate more efficiently. Each notification provided by the MutationObserver Web API includes details of changed objects. In some examples, the filter 404 is configured to process the details, such as new objects added to the DOM and/or attribute changes to existing objects in the DOM. In a similar fashion, the filter 404 can be configured to subscribe to Windows UI events via the UI Automation Framework API for various types of controls. In these examples, the filter 404 is configured to provide the changed objects or elements to the classifier 406 for further processing. The filter 404 is also configured to take no additional action where no changed objects or elements are identified.

In some examples, the classifier 406 is configured to determine whether changed DOM objects or automation/hook elements represent an error message. In these examples, the classifier 406 is configured to receive the changed objects or elements and to execute one or more classification processes depending on the type of data stored in the objects or elements. For example, to handle a case where the type of data stored in the objects or elements is text data, the classifier 406 is configured to execute a keyword search process to identify whether the text data includes any keywords from the user-configurable dictionary described above with reference to the monitor 102 of FIG. 1. In some examples, the keyword search process is configured to search for literal keywords and text that matches one or more regular expressions stored in metadata associated with the signatures. To handle a situation in which the type of data is image data, the classifier 406 can be configured to execute an OCR process (e.g., transmit a request to an OCR cloud API or execute locally) to extract text from the image data and to execute the keyword search on the extracted text.

Additionally or alternatively, to handle a situation in which the type of data is image data, the classifier 406 can be configured to execute a ML process trained to identify features within the image data that are commonly displayed in error messages. For example, the classifier 406 can execute a convolutional neural network trained to detect error messages within image data. In this example, the convolutional neural network can be trained to detect error text and/or other visual objects, such as stop sign icons, warning sign icons, and the like within the image data. It should be noted that the classification techniques described above can be combined in various examples of the classifier 406 in accordance with the principles described herein. The classifier 406 is further configured to provide changed objects or elements that represent an error message to the signature generator 408 for further processing. The classifier 406 is also configured to take no further action where the changed objects or elements do not represent an error message.

In some examples, the signature generator 408 is configured to generate signatures that uniquely identify error messages and to provide the signatures to the system interface 402 for subsequent processing. As described above, each signature can incorporate a subset of the representation of UI of the monitored application. This subset can be a set of identifiers of various DOM objects or automation/hook elements of a UI hierarchy that begins with a root object or element and terminates with an object or element representing an error message. The UI hierarchy can include an identifier of the monitored application, an identifier of a window or page in which the error message is displayed, an identifier of the main process that generated the error message, an identifier of the object or element that represents the error message. In some examples, the identifier of the monitored application can be a name of the monitored application. The identifier of a window or page can be the window title or the page title. The identifier of the main process can be a name of the process and a module path for the monitored application or a URL at which the monitored application can be accessed. The identifier of the object or element can be an object name (and attribute data) and/or an automation identifier, which can ensure the signature is robust with regard to various human language configurations. Examples of object or element structures used to store identifiers can include tuples such as <object type, object id, object class> and <div, #errorId, #errorclass>. By including application and UI hierarchy information within the signature, the signature generator 408 ensures uniqueness of the signature, even across multiple monitored applications, thereby enabling precise and accurate automatic remediations.

In some examples, the signature generator 408 is configured to further identify the object or element within the set of identifiers by including additional information regarding the context of the object or element as rendered in the UI. In these examples, the signature generator 408 is configured to determine coordinates of the error message within the UI through OCR or UI automation messages. The signature generator 408 is further configured to identify rendered UI elements positioned to the left, top, right, and bottom of the error message. The signature generator 408 can be further configured to identify a title of the error message and to store any part of all of this information in the object or element identifier. Adding this additional information to the object or element identifier can be particularly useful when processing error messages displayed within new windows (e.g., dialog messages).

In some examples, the signature generator 408 is configured to include metadata descriptive of the error (e.g., error code, stack trace, process name, business organization, region, etc.) in signatures. This metadata can include user-configurable regular expressions to broaden the text classified by the classifier 406 as an error message.

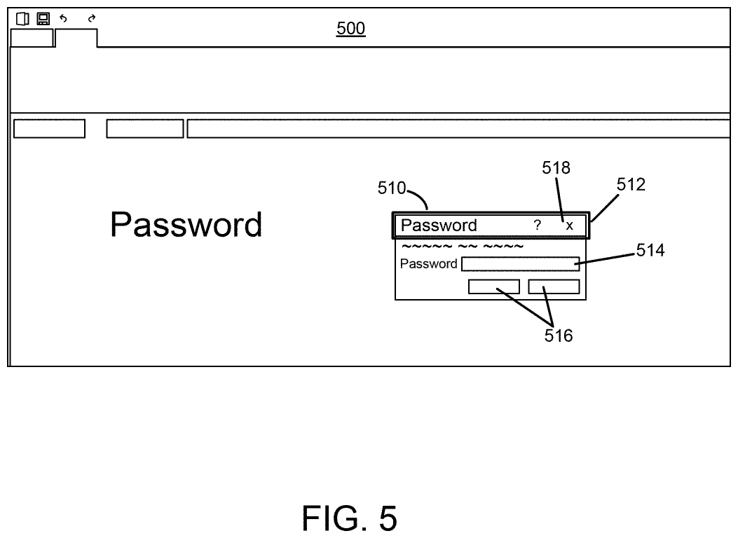

In some examples, the system uses CV and/or ML methods to recognize various software UI elements and patterns and trigger the appropriate rules, as illustrated in the examples of FIGS. 5-7 below. In some examples, this includes the use of Optical Character Recognition (OCR) to identify and/or match text.

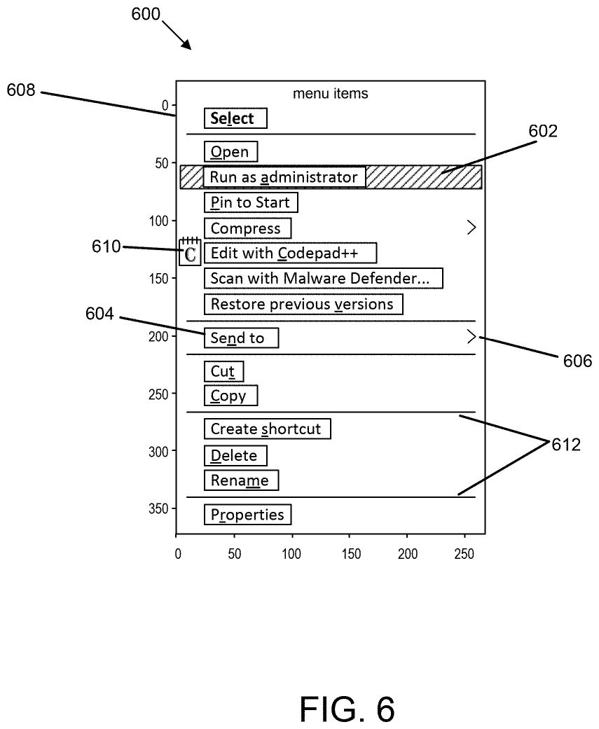

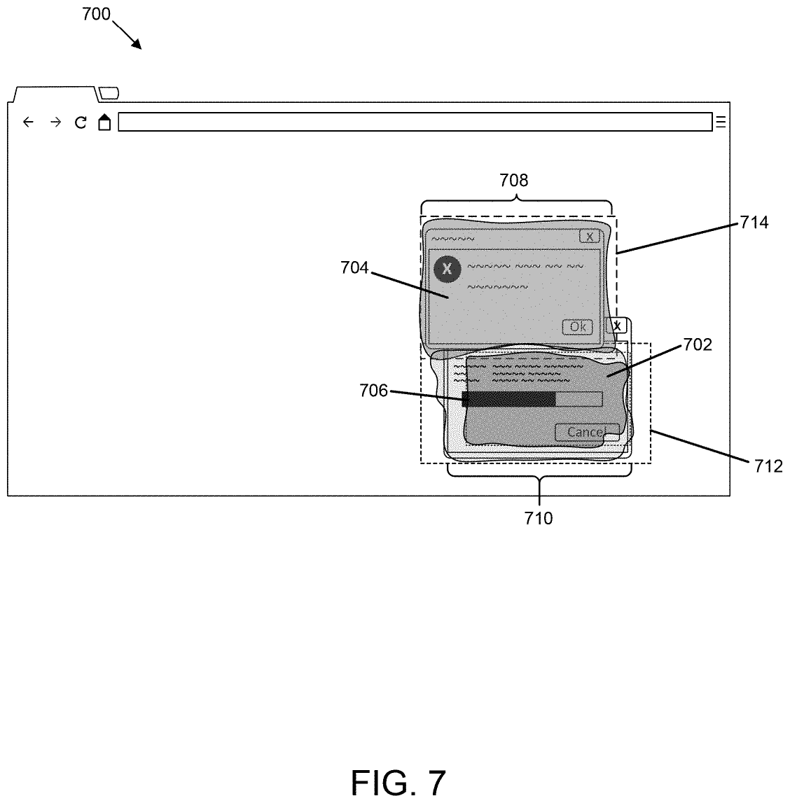

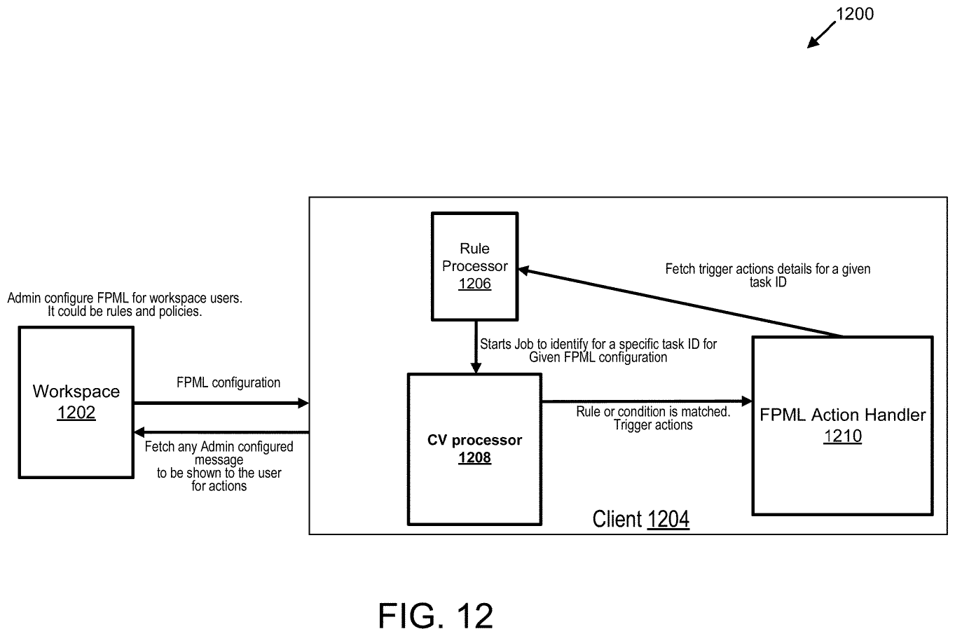

FIG. 5 illustrates an example password entry dialog box 510 being recognized via a CV process in accordance with an example of the present disclosure. The disclosed methods can detect UI elements or software objects such as dialog and menu item groups and their various attributes. In the examples of FIGS. 5-6, the system can use CV to process a still frame or screenshot of the content displayed in the user session. In these examples, the system can recognize UI elements using CV, even without invoking an ML model. Alternatively or additionally, the system can use ML, as in the example of FIG. 7 below. In some examples, the CV and/or ML models are applied by a CV processor, as described in the example of FIG. 12 below.

In this example, the CV model can first apply edge detection techniques (such as a Sobel filter, a Canny edge detector, a Deriche edge detector, and the like) to identify rectangles comprising windows, buttons, title bars, or other software UI elements or parts thereof. For example, the CV model can use rectangle identification to distinguish password entry dialog box 510 from the larger application window 500, as well as to identify title bar 512, password entry field 514, buttons 516, etc. Likewise, the CV model can use morphological operations to identify other contours.

Next, the CV model may filter out extraneous or irrelevant UI objects, such as software UI elements that are unlikely to belong to dialog 510 or menu item groups, such as those in the example of FIG. 6. For example, the system can make use of the fact that dialogs and menu item groups generally have larger areas than other typical software UI elements such as text, buttons, etc. In particular, dialog 510 has an area intermediate between UI elements 512, 514, and 516, which it contains, and application window 500, within which dialog 510 is subordinate. Similarly, in the example of FIG. 6, menu 600 has an area larger than individual menu items 602 and 604, while these individual menu items have areas larger than the menu text and icons 606 and 610.

To filter out irrelevant objects, the system can identify edges belonging to a rectangle or square, calculate the area of the rectangle or square, and compare the area to a threshold value. The system can determine top, left, height, and width dimensions for contours and compute the contour areas. The CV model may also ignore contours with fewer than three vertices, or with too many vertices (e.g., more than four, five, or six vertices), and can identify contours with area larger than a threshold, or within a given range.

Next, the CV model may classify an identified rectangle or square area to be a dialog, a menu item, or another UI element using a guided heuristics method. The system can use visual characteristics to identify dialogs, menu item groups, or other UI elements. As shown in this example, dialog 510 may have a title bar area 512 of a different color from the dialog body, an icon 518 to close dialog 510, and one or more buttons 516 (i.e. smaller rectangles). In another example, a dialog may include an icon (such as the error or warning icon 306 in the example of FIG. 3), and/or dialog message text (such as text 204 in the example of FIG. 2). The CV method can seek matches for one or more of these visual characteristics to identify a dialog or menu item group.

For example, the client device can receive a rule including a rule condition and rule action from the workspace server, and the rule condition can contain one or more UI element specifications, which can describe the UI element to be matched. For example, in Listing 1 below, the example FPML tag includes specifications of particular text for a dialog title and button text, as well as an icon type. In another example, the rule can contain a specification of a particular icon, cursor, or image. In some examples, the rule condition may be satisfied by an exact match, e.g. an exact text match, or a byte-for-byte image match. In some examples, the rule condition may be satisfied by a close match, for example text matching up to capitalization, punctuation, spacing, or synonymous words, or images matching up to small hue or color differences, blurring or sharpening, resolution, small changes in aspect ratio, or other minor image manipulations. In other examples, the system can use ML to determine whether the rule condition is satisfied. For example, the system can use ML trained on training sets of similar text or images to determine a match to text or an image. Such usage of ML is described further in the example of FIG. 7 below. In some examples, the system may use ML to recognize any icon and/or image.

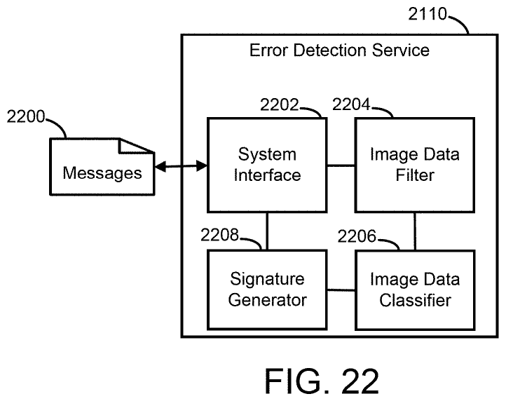

Finally, the CV model may identify details for the dialog 510, or other UI element, such as menu item groups. For example, the system can apply CV to scan the upper area of the dialog 510 to identify a rectangle corresponding to title bar 512 of dialog 510, and/or can apply OCR on the top area to identify the dialog title (in this example, “Password”) corresponding to title bar 512. The CV model can also identify buttons 516 as smaller rectangles, typically in the lower area of dialog 510. Moreover, the system can apply OCR to identify the button text of buttons 516, as well as the contents of any message in the dialog 510. The system can also apply an ML model to identify any icons in dialog 510, such as error, warning, or informational icons, as disclosed herein, such as in the examples of FIG. 4 above and FIGS. 7 and 22 below.

FIG. 6 illustrates an example of menu items being recognized via a CV process in accordance with an example of the present disclosure. In this example, the CV model can identify the various menu items shown, such as items 602 and 604, by enclosed rectangles, as well as identifying icons 606 and 610, and the selection of menu item 602.

First, as in the example of FIG. 5, the CV model may identify rectangles, such as rectangle 608 bounding menu 600 and the rectangle bounding individual menu item 604. Next, the CV model can filter out UI elements unlikely to be dialogs or menu items, for example by comparing the area of rectangle 608 to a threshold and/or to the area of smaller UI elements, such as menu item 604.

Next, as in the example of FIG. 5, the system can classify identified rectangles or squares to be menu items by a guided heuristics method. For example, the system can identify menu 600 as a menu item group, at least in part because it contains equally spaced menu items, such as menu items 602 and 604. In addition, some menu items include an icon, such as icon 610. Similarly, item 604 has an arrow icon 606, indicating that a menu associated with item 604 can be expanded. The system can recognize these features of the individual menu items 602 and 604, while also using these features as cues in classifying items 602 and 604 as menu items within menu group 600. In this example, the menu group 600 also has horizontal dividers 612, which can be identified as lines with width less than menu item group 600.

Finally, as in the example of FIG. 5, the CV model may identify details of the menu item group 600. The CV model can identify individual menu items, such as items 602 and 604, by applying OCR analysis on contours identified within menu item group 600. In an example, the system can use OCR to recognize the text contents of menu items 602 and 604, and compare these against known examples, patterns, or templates. The system can also identify a currently selected menu item 602 by comparing the color attributes of menu item 602 with other menu items, such as item 604.

In another example, for security auditing purposes, the administrator may wish to monitor how often users may have selected “Run as administrator” from a pop-up menu, as shown in FIG. 6. Using the CV methods described above and/or the ML methods disclosed herein, the system can determine menu item groups and menu items. As described previously, the CV model can identify from the color attributes that item 602 (“Run as administrator”) is selected. The system can determine a location or coordinates of selected item 602 relative to menu item group 600, and/or determine an absolute location of selected item 602 from the screen. The system can also note a current mouse cursor click event to identify where the mouse click occurred.

If the click coordinates are located within the area of menu item 602, the system can record an instance of the user trying to elevate privilege by selecting “Run as administrator.” More generally, the system can use this method of combining CV to identify a UI object coordinates in conjunction with the mouse click coordinates in order to determine a click event on any control. Similarly, the system can also detect an object being focused, for example the system can determine if a button is in focus by determining its change in color or selection. Then, the system can detect an event such as a mouse click, space bar press, or enter key press, to determine that the button or control has been selected.

While the CV methods described in the examples of FIGS. 5-6 do not use ML, ML models can also be used to identify dialogs and menu item groups, as in the example of FIG. 7.

FIG. 7 illustrates an example of two windows 702 and 704 of different types being recognized via an ML process in accordance with an example of the present disclosure. In this example, the system applies ML-based CV to identify dialogs and menu item groups, for example using a neural network technique, such as a Mask Recurrent Neural Network, a Mask Region-Based Convolutional Neural Network (Mask R-CNN), or another neural network.

In particular, the system can apply a Mask Recurrent Neural Network, a Mask R-CNN, or another neural network for object detection and instance segmentation. Analogously to a Mask Recurrent Neural Network classifying an image (for example, as a cat or dog), the disclosed system and methods can classify an image as an error dialog, copy dialog, warning dialog, a different dialog type, or another UI element. Analogously to the general case, the disclosed system and methods can perform object localization to locate each dialog or UI element present in an image of a user session (e.g., by determining a bounding box and/or a mask corresponding to each UI element), and can perform object classification to predict the type of dialog or other UI element or software object localized. In some examples, the system may apply a different neural network, but can still follow the same steps disclosed in this example.

In this example, the system applies a CV ML-based neural network model to identify two dialog boxes, copy dialog 702 and error dialog 704. Using ML, the system can identify copy dialog 702, even though the title of copy dialog 702 is obscured by error dialog 704. For example, the ML model may recognize progress bar 706, which is visible in FIG. 7, and/or may recognize other attributes typical of copy dialogs, based on having been trained on a training set of copy dialog images that contain similar attributes. In some examples, the ML models can be trained on copy dialogs using a number of different images, which can be augmented using techniques such as placing a dialog image over another window image, varying the dialog image's location, and varying the dialog image's aspect ratios.

In an example, the system uses a Mask R-CNN model so as to also detect image masks such as masks 708 and 710, as shown. In an example, the system can also use a bounding box prediction model to detect just the bounding boxes 712 and 714 of dialogs 702 and 704, respectively. The ML model can be enhanced to predict a title bar bounding box. Alternatively, the system can perform image processing on the dialog bounding box 714, for example, to identify the title bar area, and can apply OCR to the identified title bar to determine the title text of dialog 704.

While in the example of FIG. 7, the ML model recognizes dialog 702 and 704, similar methods can be applied to recognize menu item groups or other UI elements. For example, the system can be trained on various dialog images for different dialog types (such as error, copy, warning, etc.) and metadata for the dialogs such as width and height can be associated with each image. In addition, the system can be trained with various base images of other applications, such as file explorer, a browser, an integrated development environment, a word processor, and the like. The system can implement data augmentation by superimposing the dialog images on the base image of the application to produce large datasets for training, testing, and/or validation. In addition, the system can obtain further variations by modifying the aspect ratio while overlaying the dialog, as well as modifying the location where these dialogs are overlaid, in order to generate augmented images with dialogs in different locations. As dialogs are rectangles, the mask area or coordinates can also be determined during data augmentation based on the size and location of placement. As the dimension and placement is automated, the data augmentation method can keep track of the actual bounding box and label of the dialogs in a given image. In some examples, the system executes a k-fold strategy to split the image data set into images for training, testing, and validation.

In another example, the system can detect a displayed icon or cursor, such as an hourglass or spinning wheel, thereby monitoring productivity loss due to slow workspace session response. In some examples, the cursor change is detected by a local process supported by an OS of the client device that also renders the UI, for example a workspace app executing in the client device to implement the workspace session. In some examples, the cursor change is detected by a CV processor implemented on the client device.

In an example, the system can detect productivity loss by hooking (for example, via a local process such as the workspace app) into the API an application uses to set the cursor. For examples, the system interface can receive, from one or more OS services, hook messages and/or UI automation messages (e.g., the hook messages 116 and/or the UI automation messages 118 of FIG. 1) descriptive of the operation of a monitored application. The OS may send a signal, WM_SETCURSOR, to the application, which allows the application to change the shape of the mouse cursor at any time. For example, the application may call the property Cursor.Current to get or set the cursor shape. In a second example, the application may set the property UseWaitCursor to change the display to hourglass. In a third example, the application may call the property Control.Cursor to get or set the shape for specific controls. In yet another example, the application may use the win32 API SetCursor to set the cursor position. The system can load the hook for each process using existing methods. Alternatively, the system may use polling to query the cursor shape.

In another example, the system can use CV and/or ML, as described in the examples of FIGS. 5-7 above, to determine that an icon or cursor such as an hourglass or spinning wheel is being displayed. For example, the ML model may first determine the cursor's location, and then take a portion of a screen image around the location to get an image of the cursor. The ML model can be trained using a number of cursor positions to classify a mouse cursor denoting a delay, e.g. an hourglass or spinning wheel. The system may execute CV neural networks, such as a Mask Recurrent Neural Network, Mask R-CNN, or another neural network, analogously to the usage of such neural networks to classify images such as a cat or dog image. In an example, the ML model can classify the mouse cursor image as denoting a delay (e.g., an hourglass or spinning wheel), or as a normal cursor shape.

When the system determines that a delay icon or cursor, such as an hourglass or spinning wheel, has been set, the system can start a timer or record timing information. Similarly, when the cursor is returned to a normal cursor shape, the system can note an end time. The system can calculate a time difference to determine how long the cursor was in a delay or busy state for a given application. This time difference can then be compared with a threshold (which may be configured by an administrator for each application) and determine whether to record a slowness or productivity loss event for the application.

In another example, the system can monitor productivity loss without requiring threshold configuration by an administrator, by tracking a cumulative average delay for each application, and/or applying statistical tests to quantify the significance of such delay. Alternatively, the system can determine the total time for a given application window from multiple event records by the same or different users. After accumulating sufficient event records, the system may automatically detect a significant deviation or variation. In one example, the system can detect significance by comparing a proportional variation to a threshold (e.g., 10% or 40%), and raise the event automatically. In another example, the system can apply statistical tests to detect the significance of a proportional variation. Such methods do not require the administrator to configure a threshold for different applications.

As these examples illustrate, the disclosed system and methods enable an administrator to monitor user sessions for error remediation, troubleshooting, security, productivity, authorization, privacy, or other applications, while only requiring a minimal amount of programming by the administrator. For example, the administrator may use structured tags or a specialized language, such as FPML, Video Processing Markup Language (VPML), Frame Processing Query Language, or Video Processing Query Language, to specify UI elements to monitor and actions to take in response to recognizing these UI elements. FPML can specify a condition to match (for example, using a “Dialog” tag) and an action to take in response to a match (a “MatchFound” tag). In particular, the condition can include a dialog or window title, text, buttons, colors, controls, and the like. The system can make use of a CV model that is designed in advance and/or an ML model that is trained in advance. Accordingly, the disclosed system and methods can simplify the application of CV and/or ML, such that the administrator can expeditiously develop such FPML tags and configure the rule with relatively little consideration of the implementation of the CV and/or ML models.

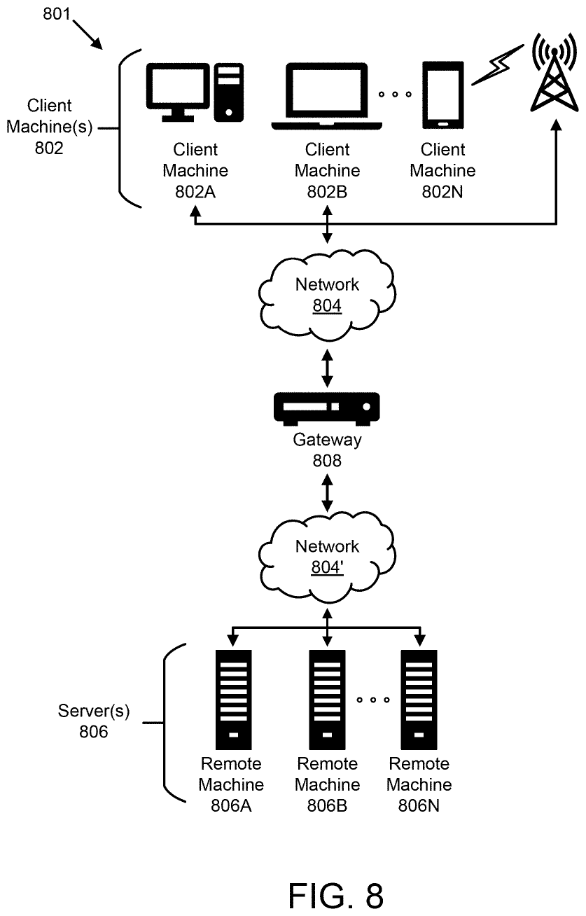

Referring to FIG. 8, a non-limiting network environment 801 in which various aspects of the disclosure can be implemented includes one or more client machines 802A-802N, one or more remote machines 806A-806N, one or more networks 804, 804′, and one or more appliances 808 installed within the computing environment 801. The client machines 802A-802N communicate with the remote machines 806A-806N via the networks 804, 804′. The computing environment 801 can also be referred to as a distributed computer system.

In some examples, the client machines 802A-802N communicate with the remote machines 806A-806N via an intermediary appliance 808. The illustrated appliance 808 is positioned between the networks 804, 804′ and may also be referred to as a network interface or gateway. In some examples, the appliance 808 can operate as an ADC to provide clients with access to business applications and other data deployed in a datacenter, the cloud, or delivered as Software as a Service (SaaS) across a range of client devices, and/or provide other functionality such as load balancing, etc. In some examples, multiple appliances 808 can be used, and the appliance(s) 808 can be deployed as part of the network 804 and/or 804′.

The client machines 802A-802N may be generally referred to as client machines 802, local machines 802, clients 802, client nodes 802, client computers 802, client devices 802, computing devices 802, endpoints 802, or endpoint nodes 802. The remote machines 806A-806N may be generally referred to as servers 806 or a server farm 806. In some examples, a client device 802 can have the capacity to function as both a client node seeking access to resources provided by a server 806 and as a server 806 providing access to hosted resources for other client devices 802A-802N. The networks 804, 804′ may be generally referred to as a network 804. The networks 804 can be configured in any combination of wired and wireless networks.

A server 806 can be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 806 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol client; a File Transfer Protocol client; an Oscar client; a Telnet client; or any other set of executable instructions.

In some examples, a server 806 can execute a remote presentation services program or other program that uses a thin client or a remote-display protocol to capture display output generated by an application executing on a server 806 and transmit the application display output to a client device 802.

In yet other examples, a server 806 can execute a virtual machine providing, to a user of a client device 802, access to a computing environment. The client device 802 can be a virtual machine. The virtual machine can be managed by, for example, a hypervisor, a virtual machine manager (VMM), or any other hardware virtualization technique within the server 806.

In some examples, the network 804 can be: a local area network (LAN); a metropolitan area network (MAN); a wide area network (WAN); a primary public network 804; and a primary private network 804. Additional examples can include a network 804 of mobile telephone networks that use various protocols to communicate among mobile devices. For short range communications within a wireless local-area network (WLAN), the protocols can include 802.11, Bluetooth, and Near Field Communication (NFC).

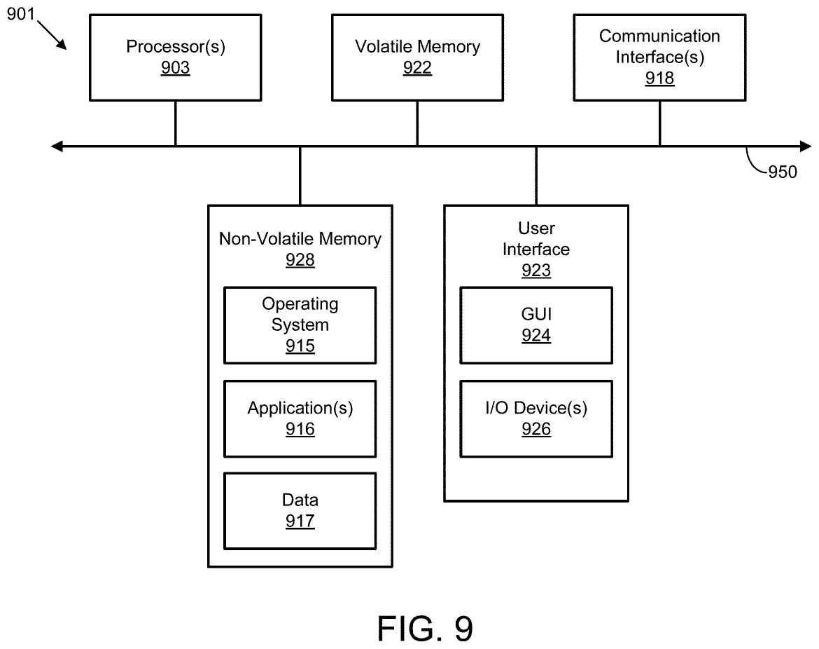

FIG. 9 depicts a block diagram of a computing device 901 useful for practicing an example of client devices 802, appliances 808 and/or servers 806. The computing device 901 includes one or more processors 903, volatile memory 922 (e.g., random access memory (RAM)), non-volatile memory 928, user interface (UI) 923, one or more communications interfaces 918, and a communications bus 950. The computing device 901 may also be referred to as a computer or a computer system.

The non-volatile memory 928 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 923 can include a graphical user interface (GUI) 924 (e.g., a touchscreen, a display, etc.) and one or more input/output (I/O) devices 926 (e.g., a mouse, a keyboard, a microphone, one or more speakers, one or more cameras, one or more biometric scanners, one or more environmental sensors, and one or more accelerometers, etc.).

The non-volatile memory 928 stores an operating system 915, one or more applications 916, and data 917 such that, for example, computer instructions of the operating system 915 and/or the applications 916 are executed by processor(s) 903 out of the volatile memory 922. In some examples, the volatile memory 922 can include one or more types of RAM and/or a cache memory that can offer a faster response time than a main memory. Data can be entered using an input device of the GUI 924 or received from the I/O device(s) 926. Various elements of the computer 901 can communicate via the communications bus 950.

The illustrated computing device 901 is shown merely as an example client device or server and can be implemented by any computing or processing environment with any type of machine or set of machines that can have suitable hardware and/or software capable of operating as described herein.

The processor(s) 903 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 903 can be analog, digital or mixed. In some examples, the processor 903 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The communications interfaces 918 can include one or more interfaces to enable the computing device 901 to access a computer network such as a Local Area Network (LAN), a Wide Area Network (WAN), a Personal Area Network (PAN), or the Internet through a variety of wired and/or wireless connections, including cellular connections.

In described examples, the computing device 901 can execute an application on behalf of a user of a client device. For example, the computing device 901 can execute one or more virtual machines managed by a hypervisor. Each virtual machine can provide an execution session within which applications execute on behalf of a user or a client device, such as a hosted desktop session. The computing device 901 can also execute a terminal services session to provide a hosted desktop environment. The computing device 901 can provide access to a remote computing environment including one or more applications, one or more desktop applications, and one or more desktop sessions in which one or more applications can execute.

Additional descriptions of a computing device 901 configured as a client device 802 or as a server 806, or as an appliance intermediary to a client device 802 and a server 806, and operations thereof, may be found in U.S. Pat. Nos. 9,176,744 and 9,538,345, which are incorporated herein by reference in their entirety. The '744 and '345 patents are both assigned to the current assignee of the present disclosure.

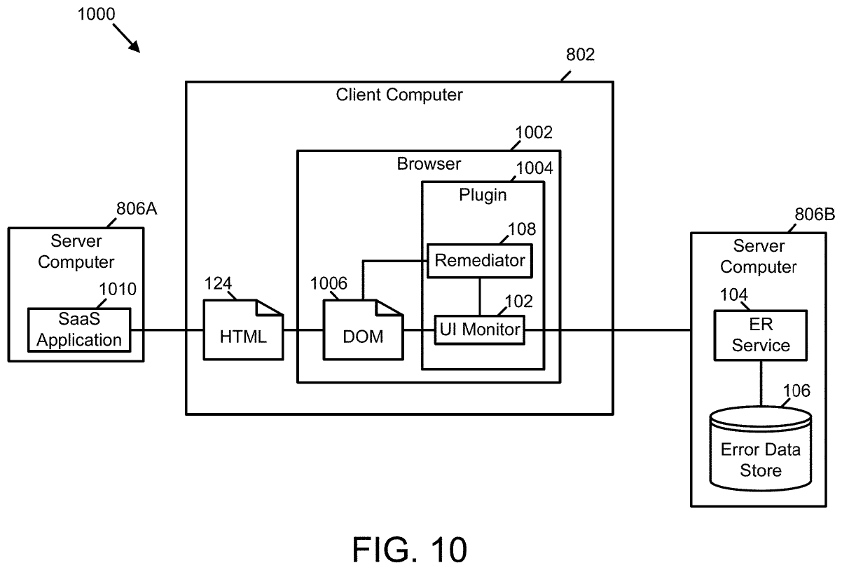

FIG. 10 illustrates an error remediation system (e.g., the system 100 of FIG. 1) configured for operation within a distributed computing platform (e.g. the network environment 801 of FIG. 8). As shown in FIG. 10, the configuration 1000 includes the client computer 802 and the server computers 806A and 806B of FIG. 8. Within the configuration 1000, the computer systems 802, 806A, and 806B are communicatively coupled to one another and exchange data via a network (e.g., the networks 804 and/or 804′ of FIG. 8).

As shown in FIG. 10, the server 806A is configured to host an SaaS and/or Web application 1010. The client 802 is configured to host a browser 1002. The server 806B is configured to host the ER service 104 and the error data store 106 of FIG. 1. The browser 1002 includes a plugin 1004 that includes the remediator 108 and the monitor 102 of FIG. 1. Many of the components illustrated in FIG. 10 are described above with reference to FIGS. 1 and 8. For purposes of brevity, those descriptions will not be repeated here, but each of the components of FIGS. 1 and 8 included in FIG. 10 is configured to function in FIG. 10 as described in FIGS. 1 and 8. However, the descriptions of any of these components may be augmented or clarified below.

As illustrated in FIG. 10, the server 806 is configured to serve the SaaS and/or Web application 1010 to the browser 1002. As part of this service, the server 806 is configured to transmit the HTML 124 of FIG. 1 to the client 802 using, for example, HyperText Transfer Protocol (HTTP), and the browser 1002 is configured to load the HTML 124 into a DOM 1006.

In some examples of the configuration 1000, the browser 1002 is configured to support DOM event notifications. In these examples, the monitor 102 is configured to subscribe to these notifications and to receive and process the notifications to detect changed DOM objects. In other examples of the configuration 1000, the browser 1002 does not support DOM event notifications. In these examples, the monitor 102 is configured to poll the browser 1002 for a copy of the DOM 1006 and process a sequence of copies of the DOM to detect changed objects. For instance, in at least one example, to receive a consistent stream of copies to analyze, the monitor 102 is configured to transmit (e.g., via the system interface 402 of FIG. 4) polling requests to the browser 1002 on a periodic basis, such as between every two HTTP requests/responses. Regardless of the technique used to detect changed objects, the components of the error remediation system illustrated in FIG. 10 are configured to interoperate to detect error messages represented in the changed objects and provide remediations as described above.

The configuration 1000 is but one example of many potential configurations that can be used to implement the system 100. For instance, in some examples, the monitor 102 is configured to provide signatures to the browser 1002 rather than the ER service 104. In these examples, the browser 1002 is configured to interoperate with the ER service 104 to drive error message detection and remediation. In other examples, the monitor 102 can be configured to communicate signatures to other processes hosted by the client 802. In other examples, the remediator 108 is configured to interoperate with the browser 1002 or other process hosted by the client 802 to provide remediations. As such, the examples disclosed herein are not limited to the particular configuration 1000 and other configurations are considered to fall within the scope of this disclosure.

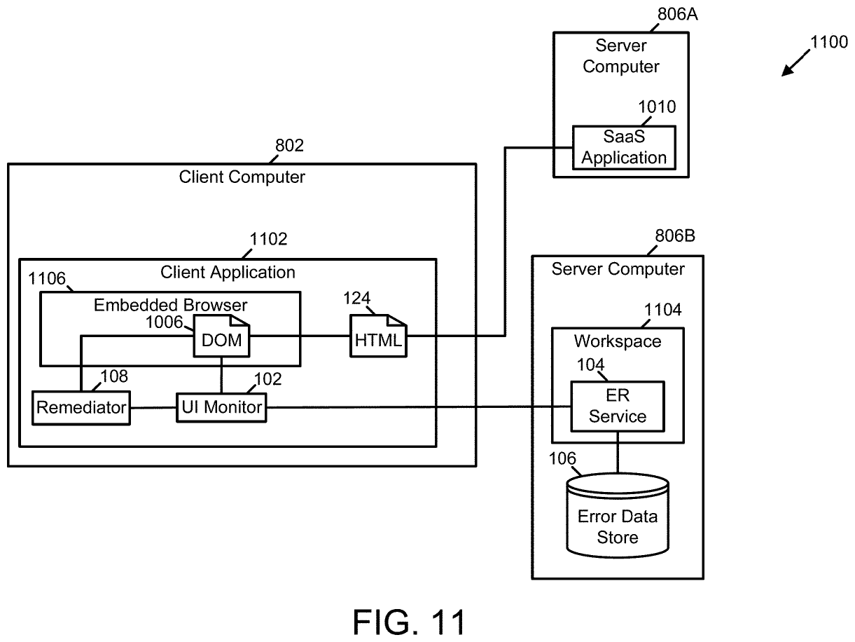

FIG. 11 illustrates an error remediation system (e.g., the system 100 of FIG. 1) configured for operation within a distributed computing platform (e.g. the network environment 801 of FIG. 8). As shown in FIG. 11, the configuration 1100 includes the client computer 802 and the server computers 806A and 806B of FIG. 8. Within the configuration 1100, the computer systems 802, 806A, and 806B are communicatively coupled to one another and exchange data via a network (e.g., the networks 804 and/or 804′ of FIG. 8).

As shown in FIG. 11, the server 806A is configured to host the SaaS and/or Web application 1010 of FIG. 10. The client 802 is configured to host a client application 1102. The client application 1102 includes an embedded browser 1106, the remediator 108 of FIG. 1, and the monitor 102 of FIG. 1. The embedded browser 1106 can be implemented, for example, using the Chromium Embedded Framework. The server 806B is configured to host a virtualization workspace service 1104 and the error data store 106 of FIG. 1. The workspace service 1104 includes, as a service endpoint, the ER service 104 of FIG. 1. Many of the components illustrated in FIG. 11 are described above with reference to FIGS. 1, 8, and 10. For purposes of brevity, those descriptions will not be repeated here, but each of the components of FIGS. 1, 8, and 10 included in FIG. 11 are configured to function in FIG. 11 as described in FIGS. 1, 8, and 10. However, the descriptions of any of these components may be augmented or clarified below.

As illustrated in FIG. 11, the server 806A is configured to serve the SaaS and/or Web application 1010 to the client application 1102. As part of this service, the server 806A is configured to transmit the HTML 124 of FIG. 1 to the client application 1102. The client application 1102 is configured to provide the HTML 124 to the embedded browser 1106 and the embedded browser 1106 is configured to load the HTML 124 into a DOM 1006.

In some examples of the configuration 1100, the client application 1102 is configured to connect to the workspace service 1104 during initialization and to update the monitor 102 and/or any of its components (e.g., the system interface 402, the filter 404, the classifier 406, and the signature generator 408 of FIG. 4). In these examples, the client application 1102 is configured to provide the SaaS and/or Web application 1010 to an end user via the embedded browser 1106. The monitor 102 is configured to detect error messages generated by the SaaS and/or Web application 1010 during its provision by the client application 1102 and to interoperate with the ER service 104 to identify remediations associated with detected error messages. To handle a situation in which a remediation to an error message is identified, the monitor 102 is configured to provide the remediation to the remediator 108. As the remediator 108 has access to the DOM 1006 in this configuration, the remediator 108 is configured to alter the DOM 1006 to include a remediation message stored in the remediation. Thus, in this configuration, the DOM 1006 is configured to cause the error message and the remediation message to be displayed concurrently to the end user.

The configuration 1100 is but one example of many potential configurations that can be used to implement the system 100. For instance, in some examples, the monitor 102 is configured to provide signatures to the embedded browser 1106 or the client application 1102 rather than the ER service 104. In these examples, the embedded browser 1106 or the client application 1102 is configured to interoperate with the ER service 104 to drive error message detection and remediation in conjunction with the remediator 108. In other examples, the embedded browser 1106 includes and/or is extended by the monitor 102. As such, the examples disclosed herein are not limited to the particular configuration 1100 and other configurations are considered to fall within the scope of this disclosure.

FIG. 12 is a block diagram of a system 1200 configured to recognize and respond to UI elements, as implemented by a specific configuration of computing devices in accordance with an example of the present disclosure. As shown in FIG. 12, system 1200 can include a workspace server 1202 and a client 1204, which can include a client computer or mobile device. One example of workspace server 1202 may be workspace service 1104 implemented in server computer 806B in the example of FIG. 11. The client computer 1204, in turn, can implement a rule processor 1206, a CV processor 1208, and an action handler 1210.

In some examples, an administrator configures rules and policies for workspace users. The configuration rules and policies can include a rule or condition to be matched, as well as an action to take upon matching. For example, the administrator may use structured tags or a language to specify the rules and policies, for example FPML, VPML, Frame Processing Query Language, or Video Processing Query Language. An example FPML rule (referred to as a “Detect” tag) to detect the warning dialog in the example of FIG. 2 is shown in Listing 1 below, including a condition to match (the “Dialog” tag) and an action to take in response to the match (the “MatchFound” tag).

Listing 1

```
<Detect>
<Dialog Title=”Warning” />
<Buttons Text=”Proceed, Cancel”/>
<Dialog IconType=”Error”/>
<Dialog IconTypeURL or Image=””/>
</Dialog>
<MatchFound>
  <RaiseEvent EventDetails=”...” />
  <ExecuteProcess Name=”...”, Path=”....” Argument = “...”/>
<UpdateRecordingAuditStatus Text=Warning dialog found for user
{user.name}”>
<RaiseUserRiskScoreinCAS RiskIndicatorDetails=”” />
<UpdateITTicket ticket=”” />
<WebHookCallBack url=””/>
<Minimum Number of Unique users>20</Minimum Number of Unique
users>
<End user message> This is a known issue and IT is studying it. For
workaround use ABC</End user message>
</MatchFound>
</Detect>
```

In the example FPML tag of Listing 1, the administrator can configure properties like the “<Dialog Title=‘Warning’ />” tag, the “<Buttons Text=‘Proceed, Cancel’ />” tag, and the “<Dialog IconType=‘Error’ />” tag to detect a dialog with a specific title, buttons, and type, respectively. In this example, the dialog title, buttons, and type correspond to the warning dialog 200 of FIG. 2. Detecting the dialog 200 and displaying a remediation message, as in Listing 1, is merely one example of applying the disclosed system and methods to perform an action in response to detecting a satisfied rule condition. Many other examples are possible, such as the ones disclosed herein below, and are not limited by the present disclosure.

In various examples, the administrator may write a script specifying the rules and policies, e.g. in FPML, or may use a UI to configure the rules and policies. In an example, the administrator may then send the rules and policies to workspace server 1202, e.g. from a client device of the administrator's. The workspace server 1202 can maintain a store of current rules and policies, and can send relevant rules and policies to the client 1204, for example when client 1204 is booted or started up, when client 1204 initiates a workspace app or workspace session, or when client 1204 connects to the workspace server 1202. In another example, client 1204 may fetch the relevant rules and policies from workspace server 1202, and/or fetch any administrator-configured message to be shown to the user for actions.

The rule processor 1206 of client 1204 can process the received FPML configuration. In response, rule processor 1206 can generate a task ID and start a job to identify matches to the rule condition of the FPML configuration associated with the task ID. The rule processor 1206 can also notify the CV processor 1208 of the job and/or the task ID. In some examples, client 1204 can use the task ID to organize and track a given FPML rule. In a non-limiting example, the rule processor 1206 may send the task ID to both the CV processor 1208 and the action handler 1210, both of which can use the received task ID to identify the rule and/or to determine what rule to execute. Alternatively, in some examples the rule processor 1206 may send some or all of the rule (e.g., some or all of the FPML tag) to the CV processor 1208 and the action handler 1210, for example the rule processor 1206 can send the rule condition to the CV processor 1208 for recognition and the rule action to the action handler 1210 to be executed.

In response to receiving the task ID from rule processor 1206, the CV processor 1208 can identify UI elements, such as software dialogs or menu items, as specified in the FPML configuration. As disclosed herein, CV processor 1208 can implement CV and/or ML methods to identify the UI elements. For example, CV processor 1208 can implement CV methods such as identifying one or more rectangles or other shapes in a candidate UI element, filtering out one or more UI elements, identifying details of a dialog or menu item group, or classifying a rectangle or other shapes using a guided heuristic. Likewise, CV processor 1208 can execute ML methods such as applying a Mask Recurrent Neural Network, Mask R-CNN, or another neural network, to apply object detection and instance segmentation. In some examples, the CV processor 1208 can generate a numerical hash value by executing a hash function on one or more characteristics of a rendered UI element, and can use the hash value to determine whether the rendered UI element matches a rule or condition of the received FPML configuration. In some examples, the rule can include conditions beyond identifying the UI elements, such as a number of affected users or user sessions, or a global number of instances (i.e., a number of instances across all user sessions on all client devices, or a particular subset of user sessions or client devices) of a matched UI element. When the rule or condition is matched, the CV processor can notify the action handler 1210, triggering actions in response to the match.

The action handler 1210 can trigger various actions in response to the match according to the FPML configuration. For example, the action handler may render a message for end users, as disclosed herein. In another example, the administrator may configure the FPML rule or policy at server 1202 to include an action presenting a temporary message to end users, such as a message that the IT department is working on resolving a known issue, and the administrator may change the message after resolving the issue. In this example, the administrator can “push” an updated FPML rule from workspace server 1202 to end users' client devices 1204 after changing the action, or the client devices 1204 can check automatically for updated rules at the workspace server 1202. In some examples, the action handler 1210 can fetch such action details from the rule processor 1206 for a given task ID. In another example, the action may include providing documentation to the end users, such as an online link or directions for a workaround solution, or providing instructions to the users, for example instructions about security or appropriate use policy.

As described above, the FPML tag can include a specification of the action to take as a consequence of a match, for example in a “MatchFound” tag as shown in Listing 1. The administrator can configure many different types of actions in response to the match. For example, the administrator can stipulate that some minimum number of unique users encounter a particular UI element, such as a dialog, before triggering a webhook or another action. In some examples, stipulating such a minimum number of users is part of the rule condition, while in other examples, it can be part of the rule action. In a second example, the administrator can configure a webhook URL to call in response to detecting a match. For example, the rule can call a microapp webhook to trigger a notification for an administrator and/or an SOC team. In yet another example, the administrator can configure the rule to raise a ticket in response to a new or unresolved error dialog or other UI element. For example, the rule could also use a microapp webhook as one implementation to raise the ticket. In still another example, the administrator can configure the rule to send events for session recording in response to a match. Via a VC from the client, an event can be sent to the VDA to help a session recording agent record the event determined using client-side CV and FPML processing. Alternatively, if the session recording agent is implemented within the client, the client can initiate session recording without the need for any Independent Computing Architecture (ICA)/Virtual Channel (VC) protocol changes.

The example FPML tag shown in Listing 1 also contains actions to take in response to a matched condition. In this example, the administrator can configure properties like the “<Minimum Number of Unique users>” tag and the “<End user message>” tag to stipulate a minimum number of affected unique users and to display a remediation message to affected users, respectively. In this example, the detected UI element corresponds to the warning dialog 200 of FIG. 2, and the action corresponds to displaying the message, “This is a known issue and IT is studying it. For workaround use ABC” when at least 20 unique users are affected by warning dialog 200. For example, the workspace server may send the remediation message to the client device's workspace app, browser, or ICA engine app.

When the match is found, the client can send event details to the workspace server, including, for example, information identifying the application, a dialog title, message, buttons, error type, and the like. The client and/or the workspace server can generate a unique hash code based on these property values. The system can use the hash code to identify expeditiously whether and how many times such a UI element and/or event has previously been recorded. As additional users encounter this condition, the workspace server can increment the recorded count associated with the hash code. Accordingly, the administrator can configure a threshold minimum number of unique users or user sessions, or a minimum count of instances encountering a specific UI element to trigger actions. In the example FPML rule of Listing 1, the action can include the workspace server sending a message to the client's workspace app or browser or ICA engine app to display a message such as “This is a known issue and IT is aware of it. For workaround use ABC.” Such a remediation message can alleviate the triaging burden by reducing the number of tickets opened by users, while also enabling administrators to keep users informed with an updated status.

Accordingly, the disclosed systems and methods, such as FPML, enable administrators to easily and expeditiously configure actions in response to various events, as well as facilitating triaging. Moreover, IT administrators can use resource management service integration to receive notifications and trigger actions to integrate with other services. For example, an administrator can leverage microapps to receive a notification when a particular dialog, UI element, or other rule condition is matched. In an example, this is implemented using the microapp builder, which can use session recording web APIs to query event or bookmark data specific to UI element or rule condition. In some examples, webhook callbacks also enable the administrator to trigger actions in response to a match. An administrator can also trigger commands to raise events or execute any process in response to a match.

In addition to automatically recording recognized events, an administrator can also configure the system to raise bookmarks for the recognized events within the session recording, so that the administrator can expeditiously review the events via a session recording player. Likewise, the administrator can configure the system to automatically cease recording the session, for example to protect users' privacy. For example, if a user navigates to a personal webmail or other personal account, the system can automatically remove any session recording video frames that show the personal account. For example, using an FPML rule, the trigger action can be to stop session recording. This can be implemented by sending a message from the client to the session recording agent, or the session recording agent can fetch the message from the workspace backend without requiring any ICA/VC protocol changes. Accordingly, the disclosed system and methods can protect users' privacy without requiring the use of a Workspace Environment Management (WEM) service. In another example, the session recording can automatically update any video frames containing private information to be obfuscated or blurred. For example, the user's client device and/or the workspace server can recognize video frames that contain a user's private information, such as a personal webmail or other personal account, and can edit the video frames so as to obfuscate or blur the private information. In another example, the client device can send a message to the workspace server instructing it to obfuscate or blur the private information, for example by identifying particular frames and/or areas of frames. Accordingly, when the administrator reviews the session recording, the private information can already be removed from the video frames.

As these examples illustrate, the disclosed system and methods enable an administrator to monitor user sessions for error remediation, troubleshooting, security, productivity, authorization, privacy, or other applications, while only requiring a minimal amount of programming by the administrator. For example, the administrator may use structured tags or a specialized language, such as FPML, VPML, Frame Processing Query Language, or Video Processing Query Language, to specify UI elements to monitor and actions to take in response to recognizing these UI elements. FPML can specify a condition to match (for example, using a “Dialog” tag) and an action to take in response to a match (a “MatchFound” tag). In particular, the condition can include a dialog or window title, text, buttons, colors, controls, and the like. The system can make use of a CV model that is designed in advance and/or an ML model that is trained in advance. Accordingly, the administrator does not need to possess expertise in ML, and only needs to perform a small amount of high-level scripting to develop such FPML tags and configure the rule.

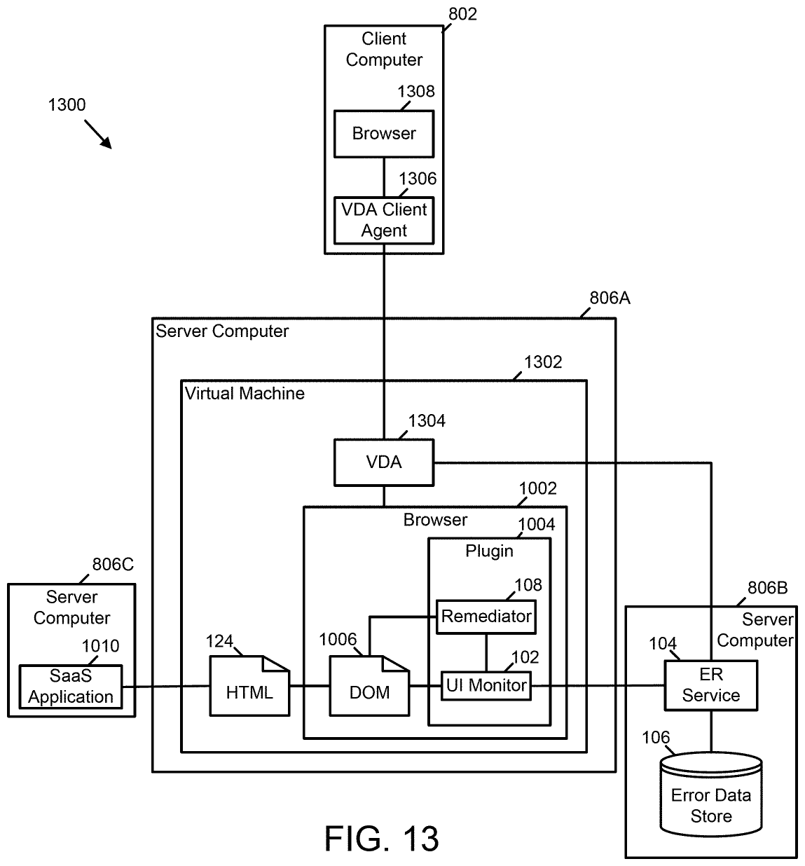

FIG. 13 illustrates an error remediation system (e.g., the system 100 of FIG. 1) configured for operation within a distributed computing platform (e.g. the network environment 801 of FIG. 8). As shown in FIG. 13, the configuration 1300 includes the client computer 802 and the server computers 806A-806C of FIG. 8. Within the configuration 1300, the computer systems 802 and 806A-806C are communicatively coupled to one another and exchange data via a network (e.g., the networks 804 and/or 804′ of FIG. 8).

As shown in FIG. 13, the server 806C is configured to host the SaaS and/or Web application 1010 of FIG. 10. The client 802 is configured to host a browser 1308 and a VDA client agent 1306. The server 806A is configured to host a virtual machine 1302. The virtual machine 1302 is configured to host a VDA 1304 and the browser 1002 of FIG. 10. The VDA 1304 and the VDA client agent 1306 are configured to establish a virtualization infrastructure between the client 802 and the server 806A. The server 806B is configured to host the ER service 104 and the error data store 106 of FIG. 1. Many of the components illustrated in FIG. 13 are described above with reference to FIGS. 1, 8, and 10. For purposes of brevity, those descriptions will not be repeated here, but each of the components of FIGS. 1, 8, and 10 included in FIG. 13 are configured to function in FIG. 13 as described in FIGS. 1, 8, and 10. However, the descriptions of any of these components may be augmented or clarified below.

As illustrated in FIG. 13, the server 806C is configured to serve the SaaS and/or Web application 1010 to the browser 1002. As part of this service, the server 806C is configured to transmit the HTML 124 of FIG. 1 to the virtual machine 1302. The virtual machine 1302 is configured to provide the HTML 124 to the browser 1002, and the browser 1002 is configured to load the HTML 124 into the DOM 1006 of FIG. 10. The components of the error remediation system illustrated in FIG. 13 are configured to interoperate with the browser 1002 to detect error messages represented in changed objects and provide remediations as described above. The VDA 1304 and the VDA client agent 1306 are configured to interoperate to provide the UI of the virtual machine 1302 to an end user via the browser 1308, thereby providing the end user with secure access to the SaaS and/or Web application 1010. In some examples, the VDA 1304 and the VDA client agent 1306 are further configured to update the monitor 102 and/or any of its components (e.g., the system interface 402, the filter 404, the classifier 406, and the signature generator 408 of FIG. 4) in the background during initialization or on-going operation of the virtual machine 1302.

The configuration 1300 is but one example of many potential configurations that can be used to implement the system 100. For instance, in some examples, the monitor 102 is configured to provide signatures to the VDA 1304 rather than the ER service 104. In these examples, the VDA 1304 is configured to interoperate with the ER service 104 to drive error message detection and remediation in conjunction with the remediator 108. More specifically, in some examples, the VDA 1304 can be configured to host the remediator 108 and/or the monitor 102. As such, the examples disclosed herein are not limited to the particular configuration 1300 and other configurations are considered to fall within the scope of this disclosure.

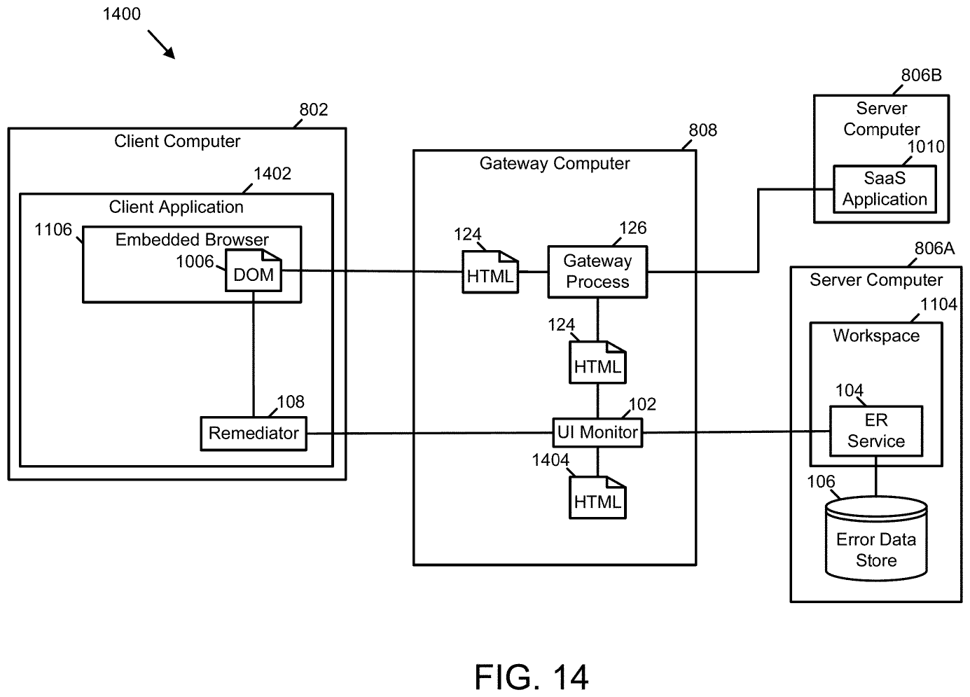

FIG. 14 illustrates an error remediation system (e.g., the system 100 of FIG. 1) configured for operation within a distributed computing platform (e.g. the network environment 801 of FIG. 8). As shown in FIG. 14, the configuration 1400 includes the client computer 802, the server computers 806A and 806B, and the gateway computer 808 of FIG. 8. Within the configuration 1300, the computer systems 802, 806A, 806B, and 808 are communicatively coupled to one another and exchange data via a network (e.g., the networks 804 and/or 804′ of FIG. 8).

As shown in FIG. 14, the server 806B is configured to host the SaaS and/or Web application 1010 of FIG. 10. The server 806A is configured to host the virtualization workspace service 1104 of FIG. 11 and the error data store 106 of FIG. 1. The workspace service 1104 includes the ER service 104 of FIG. 1. The gateway 808 is configured to host the monitor 102 and the gateway process 126 of FIG. 1. The client 802 is configured to host a client application 1402. The client application 1402 includes the embedded browser 1106 of FIG. 11 and the remediator 108 of FIG. 1. Many of the components illustrated in FIG. 14 are described above with reference to FIGS. 1, 8, 10, and 11. For purposes of brevity, those descriptions will not be repeated here, but each of the components of FIGS. 1, 8, 10, and 11 included in FIG. 14 are configured to function in FIG. 14 as described in FIGS. 1, 8, 10, and 11. However, the descriptions of any of these components may be augmented or clarified below.

As illustrated in FIG. 14, the server 806B and the gateway 808 interoperate to serve the SaaS and/or Web application 1010 to the embedded browser 1106. The gateway process 126 is configured to update the monitor 102 and/or any of its components (e.g., the system interface 402, the filter 404, the classifier 406, and the signature generator 408 of FIG. 4) prior to serving the SaaS and/or Web application 1010. As part of serving the SaaS and/or Web application 1010, the server 806B is configured to transmit the HTML 124 of FIG. 1 to the gateway process 126. The gateway process 126 is configured to transmit the HTML 124 the client application 1402. The client application 1402 is configured to receive the HTML 124 and to load the HTML 124 into the DOM 1006 for display to an end user of the client application 1402.

Further, in some examples, the gateway process 126 is configured to determine whether the HTML 124 is a response from the SaaS and/or Web application 1010 to the embedded browser 1106. For instance, in some examples, the gateway process 126 is configured to determine whether the HTML 124 is tagged with the appInstanceID previously assigned to the SaaS and/or Web application 1010 by the gateway process 126 when the SaaS and/or Web application 1010 was launched. The gateway process 126 is further configured to provide the HTML 124 to the monitor 102 where the HTML 124 is a response from the SaaS and/or Web application 1010.

In some examples of the configuration 1400, the monitor 102 is configured to compare the HTML 124 to HTML 1404 to determine whether the HTML 124 has any changed objects. The HTML 1404 is a copy of a previous version of the HTML 124. The monitor 102 is also configured to store a copy of the HTML 124 for future comparative purposes. In some examples, the monitor 102 is also configured to interoperate with the ER service 104 as described above to identify any error messages and corresponding remediations. To handle the situation where a remediation is identified, the monitor 102 interoperates with the remediator 108 to apply the remediation. As the remediator 108 has access to the DOM 1006 in this configuration, the remediator 108 is configured to alter the DOM 1006 to include a remediation message stored in the remediation. Thus, in this configuration, the DOM 1006 is configured to cause the error message and the remediation message to be displayed concurrently to the end user. The monitor 102 is further configured to provide the appInstanceID tag from the HTML 124 to the remediator 108. In cases where there may be multiple concurrent instances of SaaS and/or Web application 1010 being displayed by the embedded browser 1106, the appInstanceID tag advantageously allows the remediator 108 to apply the remediation to the DOM 1006 displaying the corresponding instance of SaaS and/or Web application 1010.

The configuration 1400 is but one example of many potential configurations that can be used to implement the system 100. As such, the examples disclosed herein are not limited to the particular configuration 1400 and other configurations are considered to fall within the scope of this disclosure.

FIG. 15 illustrates an error remediation system (e.g., the system 100 of FIG. 1) configured for operation within a distributed computing platform (e.g. the network environment 801 of FIG. 8). As shown in FIG. 15, the configuration 1500 includes the client computer 802 and the server computers 806A and 806B of FIG. 8. Within the configuration 1500, the computer systems 802, 806A, and 806B are communicatively coupled to one another and exchange data via a network (e.g., the networks 804 and/or 804′ of FIG. 8).

As shown in FIG. 15, the client 802 is configured to host a virtual application client 1504 and the VDA client agent 1306. The virtual application client 1504 includes the remediator 108 of FIG. 1. The server 806B is configured to host a virtual machine 1302. The virtual machine 1302 is configured to host a VDA 1304, a local application 1502, and the monitor 102 of FIG. 1. The VDA 1304 and the VDA client agent 1306 are configured to establish a virtualization infrastructure between the client 802 and the server 806B. The server 806A is configured to host a virtualization workspace service 1104 and the error data store 106 of FIG. 1. The workspace service 1104 includes the ER service 104 of FIG. 1. Many of the components illustrated in FIG. 15 are described above with reference to FIGS. 1, 8, 11, and 13. For purposes of brevity, those descriptions will not be repeated here, but each of the components of FIGS. 1, 8, 11, and 13 included in FIG. 15 are configured to function in FIG. 15 as described in FIGS. 1, 8, 11, and 13. However, the descriptions of any of these components may be augmented or clarified below.

As illustrated in FIG. 15, in some examples the virtual application client 1504 is configured to provide an end user with a virtual version of the application 1502 via the VDA client agent 1306 and the VDA 1304. In these examples, the virtual application client 1504 is configured to transmit via the VDA client agent 1306 (e.g., via a virtual channel) a request to the VDA 1304 to update the monitor 102 prior to launching the application 1502. The VDA 1304 is configured to process this request by interoperating with the ER service 104 to update the monitor 102 and/or any of its components (e.g., the system interface 402, the filter 404, the classifier 406, and the signature generator 408 of FIG. 4) and to initiate execution of the monitor 102. In these examples, the monitor 102 is configured to subscribe to UI automation message and/or hook messages descriptive of the UI of the application 1502 and to use these messages to detect changed elements, as described above. The monitor 102 is also configured to interoperate with the ER service 104 as described above to identify any error messages and corresponding remediations. To handle the situation where a remediation is identified, the monitor 102 interoperates with the remediator 108, via the virtualization infrastructure established by the VDA client agent 1306 and the VDA 1304, to apply the remediation. As the remediator 108 is embedded within the virtual application client 1504, the remediator 108 is configured to request that the virtual application client 1504 present a remediation message stored in the remediation in conjunction with the error message. Alternatively or additionally, the remediator 108 can install a software fix to the virtual application client 1504 and/or the VDA client agent 1306, where the remediation instructs the same.

The configuration 1500 is but one example of many potential configurations that can be used to implement the system 100. For instance, in some examples, the monitor 102 is configured to acquire UI data by loading a hook dynamic link library into the application 1502 rather than (or in addition to) via an independent process. In other examples, the monitor 102 is configured to launch a separate, independent global hook process that monitors the application 1502. In other examples, the classifier 406 of FIG. 4 is implemented as a virtual component within the monitor 102 that is physically implemented as a service in the workspace 1104. In this example, the classifier 406 is configured to expose an API that accepts changed objects or elements as text values and that returns an indication of whether the changed object or element includes an error message. In other examples, the virtual machine 1302 is configured to host the remediator 108. In these examples, the remediator 108 is configured to apply remediations to the UI of the application 1502 within the virtual machine 1302, thereby providing them to the client via the normal processing of the virtualization infrastructure established by the VDA client agent 1306 and the VDA 1304. As such, the examples disclosed herein are not limited to the particular configuration 1500 and other configurations are considered to fall within the scope of this disclosure.

### Error Remediation Processes

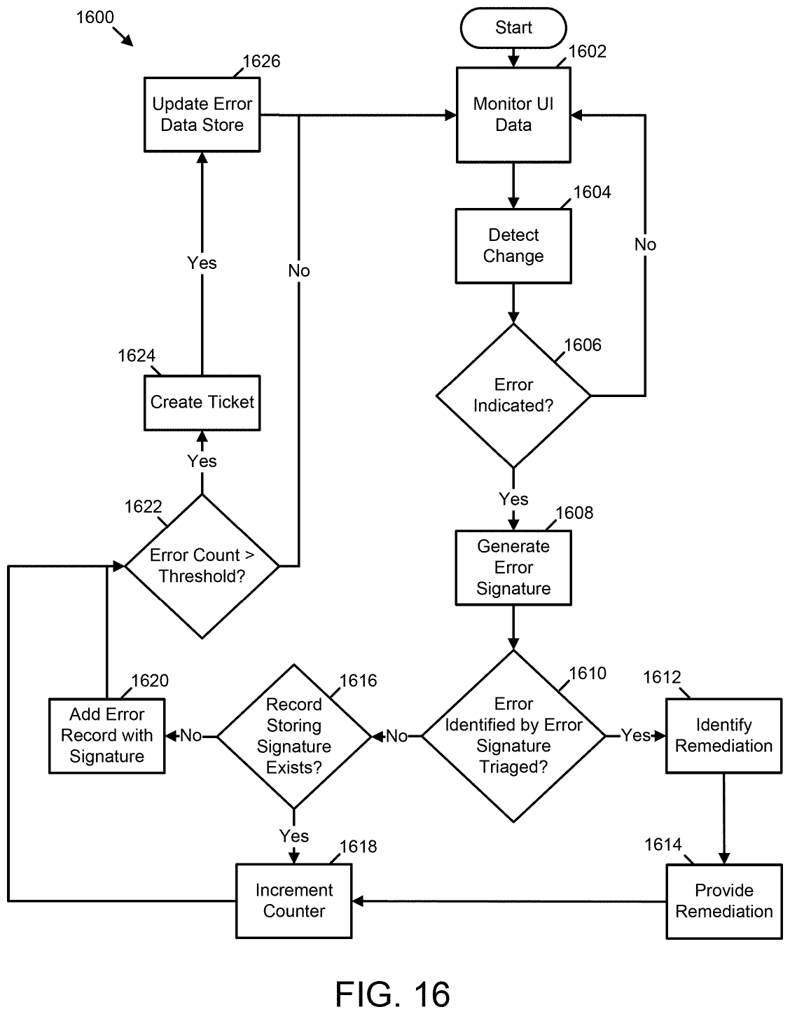

As described above, some examples of the system 100 of FIG. 1 are configured to execute error remediation processes. FIG. 16 illustrates an error remediation process 1600 executed by the system 100 in some examples.

The process 1600 starts with a UI monitor (e.g., the UI monitor 102 of FIG. 1) monitoring 1602 the UI of a monitored application. For example, the monitor can subscribe to receive notifications regarding UI data from the monitored application and/or from other system processes (e.g., hook processes and/or UI automation processes) that monitor the monitored application. Alternatively or additionally, the monitor can periodically poll the monitored application and/or other system processes to acquire UI data.

The monitor detects 1604 a change in one or more elements of the UI. For instance, the monitor can execute a filter (e.g., the UI data filter 404 of FIG. 4) that processes the UI data to detect changes therein. In some examples, the notifications received during monitoring 1602 are described of the changes and the filter need only parse them to detect the changes. In other examples, the filter maintains a sequence of representations of the UI and compares members of the sequence to detect changes.

The monitor determines 1606 whether filtered changes indicate the presence of an error message in the UI. For instance, the monitor can execute a classifier (e.g., the UI classifier 406) that classifies the filtered changes as either representing or not representing an error message. The classifier can operate on text and/or image data, as described above. Where the monitor determines 1606 that the filtered changes do not represent an error message, the monitor returns to monitoring 1602 the UI data.

Where the monitor determines 1606 that the filtered changes do represent an error, the monitor generates 1608 an error signature. For instance, the monitor can execute a signature generator (e.g., the signature generator 408 of FIG. 4). The signature can include portions of a representation of a hierarchy of UI elements present in the UI. For instance, the signature can include a root object or element of the UI and a line of descendants of the root terminating in the object or element that represents the error message.

Alternatively or additionally, in some examples the client and/or the workspace server can generate a unique hash code based on properties of the detected UI elements and/or events. In an example, the system may use the hash code to identify whether and how many times the UI elements and/or events have previously been recorded across user sessions, or within a subset of user sessions. As users encounter the same UI elements, events, or other rule conditions, the workspace server can increment a recorded count associated with the hash code. In one example, the workspace server may use the hash code to index an array or other data structure containing these counts, which can be stored in a storage device accessible by the workspace server. Alternatively, the workspace server may use the hash code as a key to a respective record associated with the rule or rule condition in a database, dictionary, or other data structure. In yet another example, the hash code may be an element or attribute of the record, for example the workspace server can retrieve the proper record by searching for the hash code or by looking up the properties of the UI elements and/or events.

Accordingly, in some examples, an IT administrator can configure a threshold minimum number of unique users or user sessions, or a minimum count of instances encountering a specific UI element to trigger rule actions associated with the UI elements, events, or rule conditions. In some examples, the workspace server can send the count to the client device together with the rule. Alternatively, the client can fetch an updated count from the workspace server at the time of recognizing the UI element or event or evaluating the rule condition. Once the client device possesses the count, it can trigger the rule action if the rule condition has been satisfied and the count exceeds the threshold. In yet another example, the workspace server can determine whether the rule condition has been satisfied, and send this decision to the client device, for example by sending the client device a logical value to indicate whether the count exceeds the threshold and/or whether the rule condition has been satisfied. In some examples, the threshold can be part of the rule condition, while in other examples, it can instead be associated with the rule action. If the rule condition has been satisfied and the count exceeds the threshold, the client device and/or the action handler can proceed to execute the action.

An ER service (e.g., the ER service 104 of FIG. 1) determines 1610 whether the error message has been triaged by support personnel. For instance, the monitor can transmit a request to the ER service that includes the signature. In response, the ER service can search a collection of error records (e.g., the error data store 106) to determine whether a record storing the signature and a remediation exists in the collection. Where the ER service determines 1610 that a record storing the signature and the remediation exists in the collection, the ER service identifies 1612 the remediation by accessing a field in the record storing an identifier of the remediation.

Where the ER service determines 1610 that no record storing the signature and a remediation exists in the collection, the ER service determines 1616 whether a record storing the signature exists in the collection. Where the ER service determines 1616 that a record storing the signature exists in the collection, the ER service increments 1618 one or more counters in the record. For instance the ER service may increment 1618 an instance counter in the record, a user counter (e.g., where a user encountered the error for the first time in this instance), and an organization counter (e.g., where a user associated with a business organization was the first to encounter the error in this instance). In these examples, the error records may be stored in association with lists of users and organizations who have encountered the error. Where the ER service determines 1616 that no record storing the signature exists in the collection, the ER service adds 1620 a record storing the signature to the collection.

A remediator (e.g., the remediator 108 of FIG. 1) provides 1614 the remediation. For instance, the ER service can transmit the remediation to the monitor in response to its early request and the monitor can transmit a request to the remediator to execute the remediation. Alternatively or additionally, the ER service can bypass the monitor and transmit the remediation directly to the remediator. In any case, such provision 1614 can include displaying a remediation message in conjunction with the error message. Alternatively or additionally, such provision can include deploying a fix to a component installed on the system hosting the remediator.

The ER service determines 1622 whether the counter stored in the record has transgressed a user-configurable threshold value (e.g., 1, 5, 10, 20, 50, 100, etc.). Where the ER service determines 1622 that the counter has not transgressed the threshold value, the ER service terminates this instance of processing. Where the ER service determines 1622 that the counter has transgressed the threshold value, the ER service creates 1624 a support ticket (e.g., by transmitting a request to a support automation system) where no ticket or remediation for the error exists. The ER service updates 1626 the collection with the ticket number and terminates this instance of processing.

Processes in accordance with the process 1600 enable the system 100 to detect and quickly remediate errors encountered by end users, as described herein.

### Error Triage Interface

As described above, in various examples disclosed herein, a triage interface (e.g., the triage interface 110 of FIG. 1) provides a user interface to enable support personnel to triage errors encountered by end users and provide remediations to the errors. FIG. 17 illustrates one example of a triage interface screen 1700 provided by one example of the triage interface.

As shown in FIG. 17, the screen 1700 is organized into columns and rows. In some examples, the triage interface is configured to provide a row for each an error record stored in an error data store (e.g., the error data store 106 of FIG. 1), subject to one or more filters. Types of information stored in or associated with an error record that can be used by the triage interface to filter the rows provided in the screen 1700 include business organization, region, site, user, and error message to name a few.

As shown in FIG. 17, the screen 1700 includes an app/URL column 1702, an error column 1704, an impact column 1706, a remediation message column 1708, a remediation link column 1710, and an update column 1712. The app/URL column 1702 includes a set of controls that each display an identifier (e.g., a name) of an app/URL that generated one or more error messages. The error column 1704 includes a set of controls that each display an error message encountered by an end user. The impact column 1706 includes a set of controls that each display a number of end users who have encountered the error message. The remediation message column 1708 includes a set of controls that each are configured to accept text articulating a remediation message to display in conjunction with the error message. The remediation link column 1710 includes a set of controls that each are configured to accept text articulating a hyperlink to display in conjunction with the error message. The hyperlink can, for example, link to an article describing a workaround for the error or a fix for the error. The update column 1712 includes a set of controls that are configured to be selectable via input. In some examples, selection of a control in the column 1712 selects the row including the selected control.

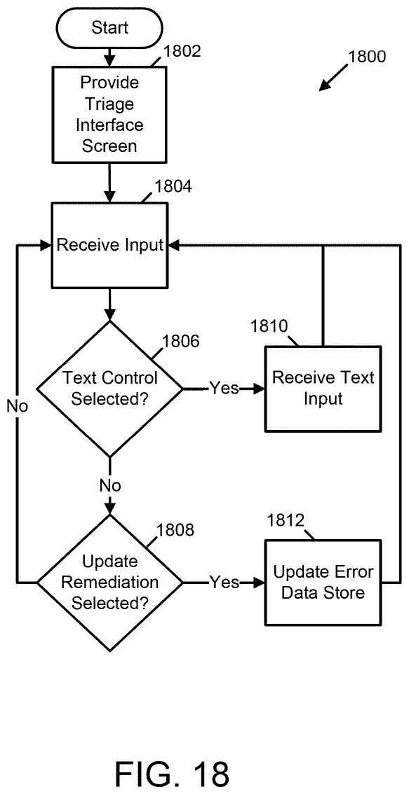

In some examples, a triage interface is configured to execute a triage process using the screen 1700. One example of a triage process 1800 in accordance with these examples is illustrated in FIG. 18. As shown in FIG. 18, the process 1800 starts with the triage interface providing 1802 a triage interface screen (e.g., the screen 1700 of FIG. 17). The triage interface receives 1804 input (e.g., a selection of a control of the interface screen). The triage interface determines 1806 whether a text control (e.g., a control from either column 1708 or column 1710) was selected.

Where the triage interface determines 1806 that a text control was selected, the triage interface receives 1810 text input and stores that input in the selected control. Where the triage interface determines 1806 that a text control was not selected, the triage interface determines 1808 whether an update control (e.g. a control from column 1712) was selected.

Where the triage interface determines 1808 that an update control was not selected, the triage interface returns to receiving 1804 input. Where the triage interface determines 1808 that an update control was selected, the triage interface updates 1812 an error record associated with the selected row. In executing the update, the triage interface replaces the values in the error record with the contents of the text controls in the selected row.

### Session Triage System

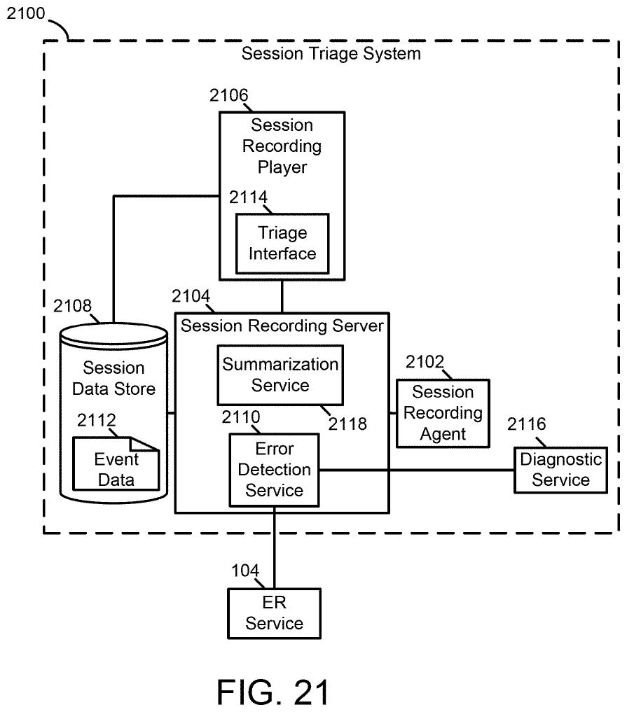

In some examples, a session triage system is configured to identify, within live or recorded session data, events in need of triage by support personnel. These events can include error messages and other events that a session recording system is configured to identify and present for triage. In some examples, the error messages can be displayed by applications (e.g., the monitored application 114 of FIG. 1) within an interactive computing session described by the session data. The monitored applications can include any process capable of displaying information within the UI of a client device, such as locally executed applications, web applications, SaaS applications, and the like. FIG. 21 illustrates a logical architecture of a session triage system 2100 in accordance with some examples. As shown in FIG. 21, the system 2100 includes a session recording agent 2102, a session recording server 2104, a session recording player 2106, a session data store 2108, and a diagnostic service 2116. The recording server 2104 hosts an error detection service 2110 and a summarization service 2118. The session player 2106 hosts a session triage interface 2114. The data store 2108 includes event data 2112.

FIG. 21 further illustrates the ER service 104 of FIG. 1. For purposes of brevity, the description of the ER service 104 is not repeated here, but the ER service 104 is configured to function in FIG. 21 as described in FIG. 1. The description of the ER service 104, however, may be augmented or clarified below.

In some examples, the detection service 2110 is configured to detect and record error messages present within session data by acquiring and processing the session data. This session data can include independent computing architecture (ICA) data that is descriptive of a plurality of interactive computing sessions. The detection service 2110 can be configured to acquire the session data using a variety of techniques. For instance, in some examples, the detection service 2110 is configured to acquire session data by registering, with the recording server 2104, to receive live session data as it is generated by, and received from, the agent 2102. These examples will be described further below.

In other examples, the detection service 2110 is configured to acquire session data by retrieving session recordings including the session data from the data store 2108. More specifically, in these examples, the detection service 2110 is configured to retrieve the session recordings in response to a system generated message, such as expiration of a timer or receipt of a new session recording (e.g., via an upload to the session recording server 2104). To handle either case, the detection service 2110 can be configured to poll the data store 2108 for any new session recordings generated by the agent 2102, and stored in the data store 2108, by the recording server 2104, since the last successful polling operation.

In some examples, the data store 2108 is organized to associate each recording of a session of the plurality of interactive computing sessions with a corresponding set of session data. The session data can describe operations executed within an interactive computing session between a client and a server. Examples of the operations that can be recorded in fields within the session data include I/O operations (e.g., keyboard and/or a mouse input, video and audio output, writes to and reads from file and registry storage, etc.), processing operations (e.g., threads/processes executed and/or terminated), security operations (user login, security exceptions, etc.), and the like.

In certain examples, the data store 2108 is further organized to associate each recording with a corresponding subset of the event data 2112. The event data 2112 can describe errors and other system events of interest to support personnel. For instance, the event data 2112 can include attributes of errors encountered by end users within session recordings. Examples of attributes of errors that can be stored in fields within the event data 2112 include a signature generated for the error, the text included in the error message, the triage status of the error, a timestamp indicating when the error message was displayed within its corresponding session recording, and image data including the error message. Additionally or alternatively, the event data 2112 can include attributes of events other than errors that occur within session recordings. Examples of the attributes of other events that can be stored within the event data 2112 include identifiers of files and/or registry keys accessed during the session recording, identifiers of security exceptions raised within the session recording, a timestamp indicating when the event was identified within the session recording, and a the triage status of the event (e.g., where the event is a security exception or some other event that needs to be triaged). It should be noted that, in some examples, non-error events are generated by interoperation between the agent 2102 and the recording server 2104 as part of their normal operations.

In some examples, the data store 2108 can be further organized to store additional metadata descriptive of each session recording. For instance, in certain examples, the data store 2108 includes fields that store an overall triage status for each session recording, an identifier of the user interacting with the computer system in the session recording, an identifier of a business organization associated with the end user, and any applications that generated error messages within the session recording. In some examples, the overall triage status can indicate whether the session recording has been triaged. Values stored in the overall triage status field can indicate that none of the events associated with the session recording have been triaged (i.e., the overall triage status is not started), at least some of the events associated with the session recording have been triaged (i.e., the overall triage status is in progress), or all of the events associated with the session recording have been triaged (i.e., the overall triage status is complete).

In some examples, the values stored in the overall triage status can indicate a brief summary, where the overall triage status is in progress. For instance, in some of these examples, this brief summary can indicate a number of events associated with the session recording that have been triaged as compared to the total number of events associated with the session recording. In other examples, the brief summary can indicate a number of events associated with the session recording that are pending triage as compared to the total number of events associated with the session recording. Further, in some examples, the brief summary can indicate a number of events associated with the session recording that are pending triage as compared to a total number of events associated with the session recording that share some commonality with the number of events. For instance, the brief summary can indicate that N of M security event are pending triage (or have been triaged).

In some examples, the detection service 2110 is configured to identify error messages within the session data by first identifying changes to image data stored within the session data and then analyzing those changes to determine whether the changes include an error message. In certain examples, the detection service 2110 is configured to construct and/or inspect a time sequence of one or more UIs executing within the session. The detection service 2110 can be configured to identify the changes to the UIs by contrasting consecutive frames of the image data and recording differences between the consecutive frames. These differences can include, for example, UI elements added between consecutive frames. In other examples where the session data expressly specifies image data that has changed between consecutive frames, the detection service 2110 is configured to simply parse the session data to identify changes to image data.

In some examples, the detection service 2110 is configured to determine whether any identified changes include error messages by executing a classifier. This classifier can be configured according to any of a variety of classification techniques. For instance, in some examples, the detection service 2110 is configured to execute a classifier that inspects the identified changes using an OCR process and searches any text identified by the OCR process for one or more keywords associated with error messages within a user-configurable dictionary. Examples of words that can be included in this dictionary include “failure,” “exception,” “error,” “terminated,” “denied,” “fatal,” and the like. In some examples, the detection service 2110 is configured to periodically update the user-configurable dictionary with synonyms via a cloud service API, such as the Thesaurus API. Further, in some examples, the detection service 2110 is configured to expose the user-configurable dictionary as a service endpoint. In some examples, the detection service 2110 is configured to label an identified change as including an error message where the identified change includes a text value matching a word from the dictionary. Alternatively or additionally, the detection service 2110 can be configured to execute a classifier trained to identify text and/or icons within images that are commonly presented in error messages.

In some examples, the detection service 2110 is configured to generate a signature that can be used to identify future instances of an error message. This signature can be similar to, or the same as, a signature that would be generated by the monitor and can be generated from processed image data and/or other portions of session data. In some examples, the signature includes a representation of a hierarchy of UI elements. This UI hierarchy can include a representation of a root UI element and can continue through a line of descendants from the root UI element to the error message. For instance, in one example, the hierarchy includes a set of identifiers comprising an identifier of an application, an identifier of a window or page of the application in which the error message was displayed, an identifier of the main process that generated the error message, and/or an identifier of the error message (error code, error message text, hash generated from any combination of the error code, error text, etc.).

To illustrate, in one example, the monitored application 114 can be a web application (A1) that executes a main process (P1) that has a main window (W1) with several UI elements (E1, E2, and E3). Within this context, A1 can display an error message within a new window (W2) containing several new UI elements (E4, E5, and E6). Assuming E6 is the error message, the signature can include a UI hierarchy such as A1->P1->W2->E6. Alternatively or additionally, A1 can display an error message within the W1 as element E3. The signature for this error message can include a UI hierarchy such as A1->P1->W1->E3.

In some examples, the detection service 2110 is configured to interoperate with the ER service 104 to store signatures within error records or identify remediations associated with error messages. In these examples, to store signatures or retrieve remediations, the detection service 2110 is configured to transmit requests to the ER service 104. These requests can include the signatures. Further, in these examples, the detection service 2110 is configured to receive and process responses to the requests. To process the responses, the detection service 2110 is configured to parse the responses to identify acknowledgments or remediations. Acknowledgements indicate the error messages associated with the signatures are untriaged. Remediations indicate that the error message associated with the signatures are already triaged.

In certain examples, to handle identified acknowledgements received from the ER service 104, the detection service 2110 is configured to store one or more portions of event data 2112 descriptive of the acknowledged error message in association with a point in the session data at which the acknowledged error message is recorded. These portions of the event data 2112 can include the signature generated for the acknowledged error message, the text included in the acknowledged error message, the triage status of the acknowledged error message (e.g., not started), a timestamp indicating when the acknowledged error message was displayed within the session recording, and/or image data including the acknowledged error message. To handle identified remediations, the detection service 2110 is configured to terminate further processing of the error message, as the error message has already been triaged where a remediation exists within the error data store. It should be noted, however, that the detection server 2110 will continue processing subsequent session data as described herein.

As described above, in some examples, the detection service 2110 is configured to acquire session data by registering, with the recording server 2104, to receive live session data associated with a session as the session data is generated by the agent 2102. In these examples, the detection service 2110 is configured to receive a stream of messages including the session data from the recording server 2104. To handle these messages, the detection service 2110 is configured to parse the messages, extract the session data, and process the session data as described above to detect and record error messages present within the session data.

In some examples, the detection service 2110 is further configured to generate and transmit, to the diagnostic service 2116, messages including data descriptive error messages. This diagnostic data can include, for example, a prefix designating the subsequent data as pertaining to an error message (e.g., “SRErrorProcessing”) and the error message itself (e.g., rendered as text and/or image data). In some examples, the message is a Citrix Diagnostic Facility (CDF) trace entry that the diagnostic service 2116 is configured to process and store within a CDF trace at a location corresponding to the time at which the error message was displayed in the session. This feature enables support personnel to navigate directly to the point in the trace that corresponds to the rendering of the error message within the UI, which can increase the efficiency of troubleshooting activities performed by the support personnel. It should be noted that the diagnostic service 2116 can be hosted on the same computer system as the session recording agent 2102. However, this is not a requirement, and in some examples, the diagnostic service 2116 and the session recording agent 2102 can be hosted by different computer systems.

In some examples, the agent 2102 is configured to record session data and to transmit messages including the session data to the recording server 2104. In these example, the recording server 2104 can be configured to receive these messages, parse the messages, and store the session data the messages contain in the session data store 2108. The recording server 2104 can be further configured to include the received messages in the stream of messages to the detection service 2110 described above, where the detection service 2110 previously registered to receive live session data for the session.

In some examples, the session recording player 2106 is configured to retrieve session data from the data store 2108 and playback the session associate with the session so that support personnel can diagnose issues encountered by an end user during the session. As shown in FIG. 21, the player 2106 can include the session triage interface 2114. The session triage interface 2114 is configured to provide a user interface to interact with support personnel. This user interface enables the support personnel to identify error messages being encountered by end users and triage identified errors message by specifying remediations for the error messages. One example of a user interface screen provided by the session triage interface 2114 is described further below.

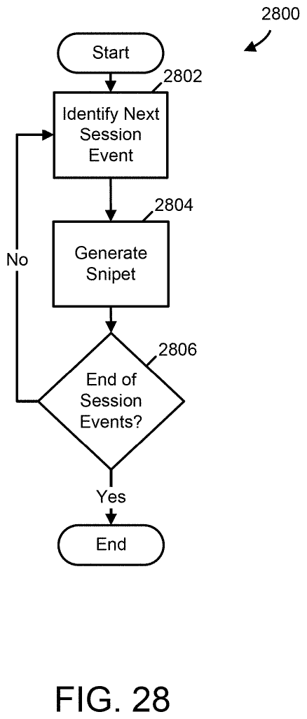

In some examples, the summarization service 2118 is configured to process requests to summarize session recordings. In these examples, the summarization service determines whether a particular session recording is large enough to warrant summarization and, if so, iteratively generates snippets for each event associated with the session recording. An examples of a summarization process executed by the summarization service 2118 in some examples is described further below with reference to FIG. 28.

To enable interoperation with the various components of the system 2100, the detection service 2110 can implement a system interface through which the detection service 2110 requests and/or receives any of a variety of messages. One example of such a system interface is shown in FIG. 22, which illustrates the logical architecture of the detection service 2110 in accordance with some examples.

As shown in FIG. 22, the detection service 2110 of FIG. 1 includes a system interface 2202, an image data filter 2204, an image data classifier 2206, and a signature generator 2208. In some examples, the system interface 2202 implements and exposes an application program interface (API) configured to transmit and/or receive messages that conform with the APIs or interfaces of other components. These components can include, for example, an ER service (e.g., the ER service 104 of FIG. 1), a session data store (e.g., the data store 2108 of FIG. 21), and a session recording server (e.g., the session recording server 2104). The messages 2200 can include session data, error records, signatures, and other data.

For instance, in some examples, the system interface 2202 is configured to interoperate with the data store 2108 (e.g., via SQL) and/or with the recording server 2104 (e.g., via an API) to request and receive session data. This session data can include, for example, image data depicting UIs of application executing within a session associated with the session data. Further, in some examples, the system interface 2202 is configured to interoperate with the ER service by transmitting messages to the ER service that include signatures received from the signature generator 2208.

In some examples, the filter 2204 is configured to receive the session data from the system interface 2202 and determine whether the session data includes changes to image data presented within the session associated with the session data. In some examples, to reduce bandwidth required to exchange image data, the session data is encoded to include only changes to previously transmitted image data. As such, in these examples, the filter 2204 is simply configured to parse the session data, extract the changed image data, and provide the changed image data, which may include error messages, to the classifier 2206. In other examples, the session data is encoded to include static portions of image data in addition to changed portions. In these examples, the filter 2204 is configured to maintain baseline image data for the entire screen presented in the session and to identify changes by comparing new image data extracted from the session data to the baseline image data. The filter 2204 is further configured to provide any changed image data to the classifier 2206 prior to updating the baseline image data with the new image data.

In some examples, the classifier 2206 is configured to classify image data as including or not including an error message. In these examples, the classifier 2206 is configured to receive the image data and to execute one or more classification processes. For example, the classifier 2206 can be configured to execute an OCR process (e.g., transmit a request to an OCR cloud API) to extract text from the image data and to execute a keyword search on the extracted text. The keyword search process can be configured to identify whether the text data includes any keywords from the user-configurable dictionary described above with reference to the detection service 2110 of FIG. 21. In some examples, the keyword search process is configured to search for literal keywords and text that matches one or more regular expressions stored in metadata associated with the signatures.

Additionally or alternatively, the classifier 2206 can be configured to execute a CV/ML process trained to identify features within the image data that are commonly displayed in error messages. For example, the classifier 2206 can execute a convolutional neural network trained to detect error messages within image data. In this example, the convolutional neural network can be trained to detect error text and/or other visual objects, such as stop sign icons, warning sign icons, and the like within the image data. It should be noted that the classification techniques described above can be combined in various examples of the classifier 2206 in accordance with the principles described herein. The classifier 2206 is further configured to provide changed objects or elements that represent an error message to the signature generator 2208 for further processing. The classifier 2206 is also configured to take no further action where the changed objects or elements do not represent an error message.

In some examples, the signature generator 2208 is configured to generate a signature that can be used to identify future instances of an error message. This signature can be similar to, or the same as, a signature that would be generated by a UI monitor (e.g., the monitor 102 of FIG. 1) and can be generated from processed image data and/or other portions of session data. In some examples, the signature includes a representation of a hierarchy of UI elements. This UI hierarchy can include a representation of a root UI element and can continue through a line of descendants from the root UI element to the error message. For instance, in one example, the hierarchy includes a set of identifiers comprising an identifier of an application, an identifier of a window or page of the application in which the error message was displayed, an identifier of the main process that generated the error message, and/or an identifier of the error message.

In some examples, the identifier of the monitored application can be a name of the monitored application. The identifier of a window or page can be the window title or the page title. The identifier of the main process can be a name of the process and a module path for the monitored application or a URL at which the monitored application can be accessed. By including application and UI hierarchy information within the signature, the signature generator 2208 ensures uniqueness of the signature, even across multiple monitored applications.

In some examples, the signature generator 2208 is configured to further identify the error message by including additional information regarding the context of the object or element as rendered in the UI displayed in the session. In these examples, the signature generator 2208 is configured to determine coordinates of the error message within the UI through OCR or CV processes. The signature generator 2208 is further configured to identify rendered UI elements positioned to the left, top, right, and bottom of the error message. The signature generator 2208 can be further configured to identify a title of the error message and to store any part of all of this information in the identifier of the error message. Adding this additional information to the identifier of the error message can be particularly useful when processing error messages displayed within new windows (e.g., dialog messages).

In some examples, the signature generator 2208 is configured to include metadata descriptive of the error (e.g., error code, stacktrace, process name, business organization, region, etc.) in signatures. This metadata can include user-configurable regular expressions to broaden the text classified by the classifier 2206 as an error message.

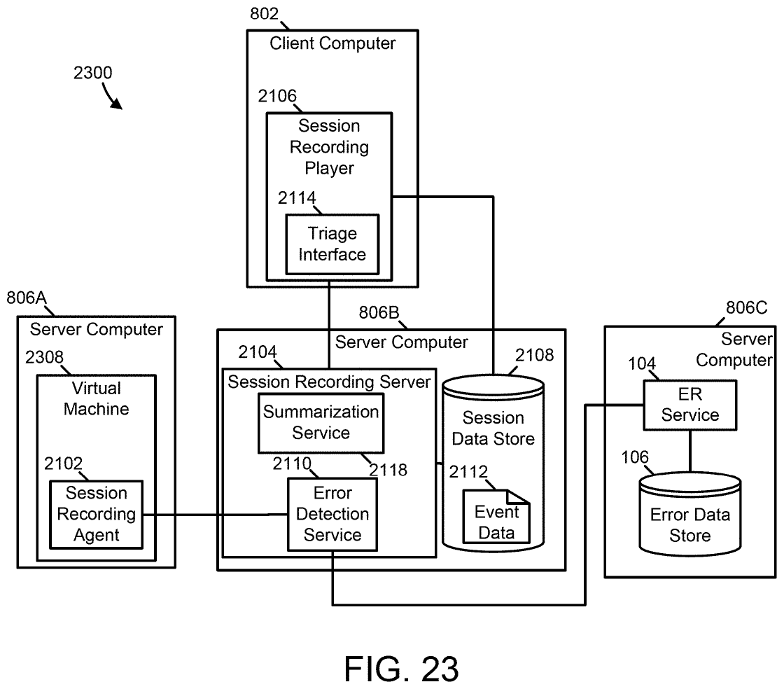

FIG. 23 illustrates a session triage system (e.g., the system 2100 of FIG. 21) configured for operation within a distributed computing platform (e.g. the network environment 801 of FIG. 8). As shown in FIG. 23, the configuration 2300 includes the client computer 802 and the server computers 806A-806C of FIG. 8. Within the configuration 2300, the computer systems 802 and 806A-806C are communicatively coupled to one another and exchange data via a network (e.g., the networks 804 and/or 804′ of FIG. 8).

As shown in FIG. 23, the server 806A is configured to host a virtual machine 2308. The virtual machine 2308, in turn, is configured to host the agent 2102 of FIG. 21. The server 806B is configured to host the recording server 2104 and the data store 2108 of FIG. 21. The recording server 2104 is configured to host the detection service 2110 and the summarization service of FIG. 21. The data store 2108 is organized to store event data 2112 of FIG. 21. The server 806C is configured to host the ER service 104 and error data store 106 of FIG. 1. The client computer 802 is configured to host the player 2106 of FIG. 21, which implements the triage interface 2114 of FIG. 21. Many of the components illustrated in FIG. 23 are described above with reference to FIGS. 1, 8, and 21. For purposes of brevity, those descriptions will not be repeated here, but each of the components of FIGS. 1, 8, and 21 included in FIG. 23 is configured to function in FIG. 23 as described in FIGS. 1, 8, and 21. However, the descriptions of any of these components may be augmented or clarified below.

As illustrated in FIG. 23, the configuration 2300 is configured to record any interactive computing sessions executed within the virtual machine 2308, detect error messages presented therein, and present those error messages to support personnel for triage. As part of this service, the agent 2102 is configured to record 1/O operations, processing operations, and security operations executed by the virtual machine 2308 at the request of one or more client processes (not shown). For instance, the agent 2102 can be configured to generate session data (e.g., ICA data) descriptive of the recorded operations. As shown in FIG. 23, the agent 2102 is configured to transmit this session data to the detection service 2110 via the recording server 2104.

The detection service 2110 is configured to identify changes to image data rendered within the session, determine whether identified changes include any error messages, generate signatures identifying any included error messages, and transmit requests to the ER service 104 to identify any remediations associated with the signatures. The ER service 104 is configured to respond to the request by transmitting messages including remediations or acknowledgements. The detection service 2110 is further configured to store, in the event data 2112, data descriptive of errors messages without associated remediations, so that those errors messages can be triaged.

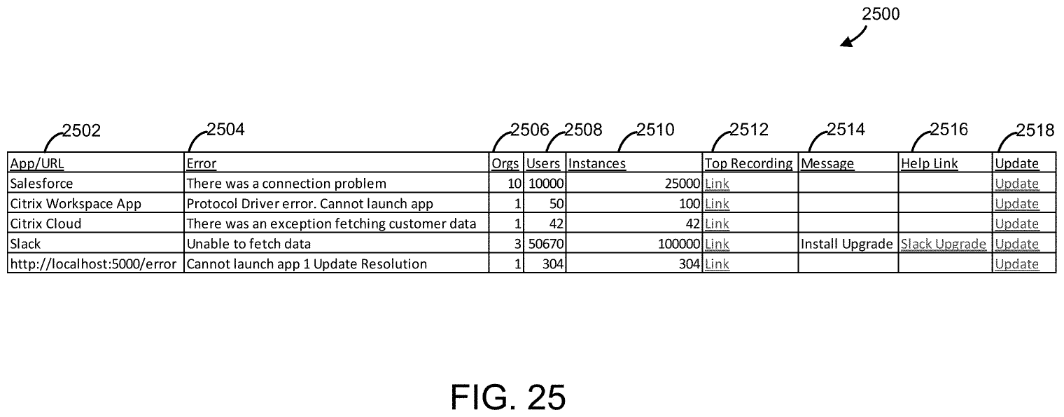

The recording player 2106 is configured to provide a session triage interface 2114 to support personnel to enable troubleshooting error messages and other events stored in the event data 2112. More specifically, the session triage interface 2114 is configured to interact with support personnel to display filtered event information and receive input specifying remediations. In some examples, the session triage interface 2114 is further configured to interoperate with the player 2106 to playback session recordings and/or session summaries. These and other aspects of the session triage interface are described further below with reference to FIGS. 25-27.

The configuration 2300 is but one example of many potential configurations that can be used to implement the system 2100. For instance, in some examples, the detection service 2110 is configured to provide signatures to the recording server 2104 rather than the ER service 104. In these examples, the recording server 2104 is configured to interoperate with the ER service 104 to drive error message detection and triage. In other examples, the detection service 2110 can be configured to communicate signatures to other processes hosted by the server 806B. Further, in some examples, the data store 2108 is hosted by a server computer that is distinct from the server computer 806B. As such, the examples disclosed herein are not limited to the particular configuration 2300 and other configurations are considered to fall within the scope of this disclosure.

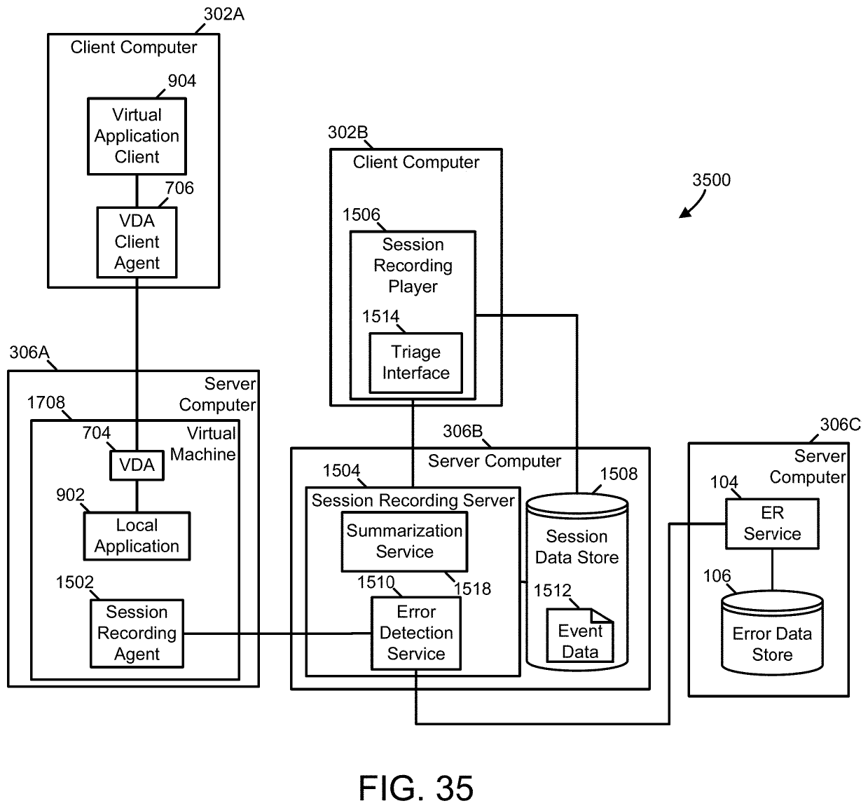

FIG. 35 illustrates a session triage system (e.g., the system 2100 of FIG. 21) configured for operation within a distributed computing platform (e.g. the network environment 801 of FIG. 8). As shown in FIG. 35, the configuration 3500 includes the client computers 802A and 802B and the server computers 806A-806C of FIG. 8. Within the configuration 3500, the computer systems 802A, 802B, and 806A-806C are communicatively coupled to one another and exchange data via a network (e.g., the networks 804 and/or 804′ of FIG. 8).

As shown in FIG. 35, the server 806A is configured to host the virtual machine 2308 of FIG. 23. The virtual machine 2308, in turn, is configured to host the agent 2102 of FIG. 21, the local application 1502 of FIG. 15, and the VDA 1304 of FIG. 13. The server 806B is configured to host the recording server 2104 and the data store 2108 of FIG. 21. The recording server 2104 is configured to host the detection service 2110 and summarization service 2118 of FIG. 21. The data store 2108 is organized to store event data 2112 of FIG. 21. The server 806C is configured to host the ER service 104 and error data store 106 of FIG. 1. The client computer 802B is configured to host the player 2106 of FIG. 21, which implements the triage interface 2114 of FIG. 21. The client 802A is configured to host the virtual application client 1504 and the VDA client agent 1306. The VDA 1304 and the VDA client agent 1306 are configured to establish a virtualization infrastructure between the client 802A and the server 806A. Many of the components illustrated in FIG. 35 are described above with reference to FIGS. 1, 8, 13, 15, 21, and 23. For purposes of brevity, those descriptions will not be repeated here, but each of the components of FIGS. 1, 8, 13, 15, 21, and 23 included in FIG. 35 is configured to function in FIG. 35 as described in FIGS. 1, 8, 13, 15, 21, and 23. However, the descriptions of any of these components may be augmented or clarified below.

As illustrated in FIG. 35, the configuration 3500 is configured to record any interactive computing sessions executed within the virtual machine 2308, detect error messages presented therein, and present those error messages to support personnel for triage. As part of this service, the agent 2102 is configured to record 1/O operations, processing operations, and security operations executed by the virtual machine 2308 at the request of one or more client processes, such as the local application 1502 as controlled by the virtual application client 1504 and the virtualization infrastructure provided by the VDA client agent 1306 and the VDA 1304. For instance, the agent 2102 can be configured to generate session data (e.g., ICA data) descriptive of the recorded operations. As shown in FIG. 35, the agent 2102 is configured to transmit this session data to the detection service 2110 via the recording server 2104.

The detection service 2110 is configured to identify changes to image data rendered within the session (e.g., by the local application 1502), determine whether identified changes include any error messages, generate signatures identifying any included error messages, and transmit requests to the ER service 104 to identify any remediations associated with the signatures. The ER service 104 is configured to respond to the request by transmitting messages including remediations or acknowledgements. The detection service 2110 is further configured to store, in the event data 2112, data descriptive of errors messages without associated remediations, so that those errors messages can be triaged.

The recording player 2106 is configured to provide a session triage interface 2114 to support personnel to enable troubleshooting error messages and other events stored in the event data 2112. More specifically, the session triage interface 2114 is configured to interact with support personnel to display filtered event information and receive input specifying remediations. In some examples, the session triage interface 2114 is further configured to interoperate with the player 2106 to playback session recordings and/or session summaries. These and other aspects of the session triage interface are described further below with reference to FIGS. 25-27.

The configuration 3500 is but one example of many potential configurations that can be used to implement the system 2100. For instance, in some examples, the detection service 2110 is configured to provide signatures to the recording server 2104 rather than the ER service 104. In these examples, the recording server 2104 is configured to interoperate with the ER service 104 to drive error message detection and triage. In other examples, the detection service 2110 can be configured to communicate signatures to other processes hosted by the server 806B. Further, in some examples, the data store 2108 is hosted by a server computer that is distinct from the server computer 806B. Further, it should be noted that the applications recorded by the agent 2102 can be any application that produces triage errors. As such, the examples disclosed herein are not limited to the particular configuration 3500 and other configurations are considered to fall within the scope of this disclosure.

### Session Triage Processes

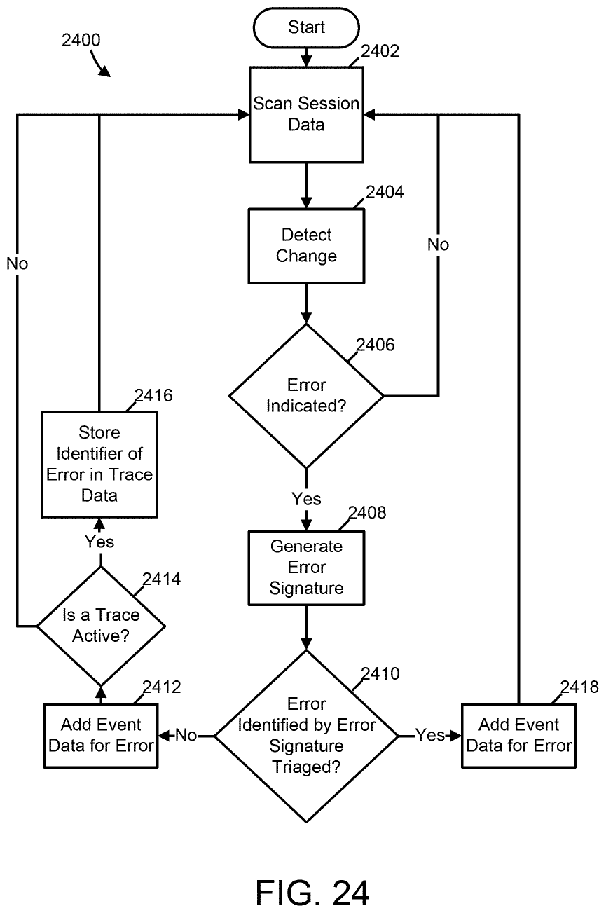

Some examples of the system 2100 of FIG. 21 are configured to execute session triage processes. FIG. 24 illustrates a session triage process 2400 executed by the system 2100 in some examples.

The process 2400 starts with a detection service (e.g., the detection service 2110 of FIG. 21) scanning 2402 session data associated with an interactive computing session. For example, the detection service can register with a session recording server (e.g., the recording server 2104 of FIG. 21) to receive live session data generated by a session recording agent (e.g., the agent 2102 of FIG. 21). Alternatively or additionally, the detection service poll a session data store (e.g., the session data store 2108 of FIG. 21) for session data and scan any session data added to the session data store since its last successfully polling operation.

The detection service detects 2404 a change in image data present within the session data. For instance, the detection service can execute a filter (e.g., the image data filter 2204 of FIG. 22) that processes the image data to detect changes therein. In some examples, the session data expressly identifies the changes and the filter need only parse the session data to detect the changes. In other examples, the filter maintains a sequence of frames of image data and compares members of the sequence to detect the changes.

The detection service determines 2406 whether filtered changes indicate the presence of an error message in the UI of the session. For instance, the detection service can execute a classifier (e.g., the classifier 2206) that classifies the filtered changes as either representing or not representing an error message. The classifier can operate on image data or text extracted from image data, as described above. Where the detection service determines 2406 that the filtered changes do not represent an error message, the detection service returns to scanning 2402 the session data.

Where the detection service determines 2406 that the filtered changes do represent an error, the detection service generates 2408 an error signature. For instance, the detection service can execute a signature generator (e.g., the signature generator 2208 of FIG. 22). The signature can include portions of a hierarchy of UI elements present in the UI. For instance, the signature can include an identifier of a root UI element and a line of descendants of the root terminating in the error message or an identifier thereof.

The detection service determines 2410 whether the error message has been triaged by support personnel. For instance, the detection service can transmit a request to the ER service that includes the signature. In response, the ER service can search a collection of error records (e.g., the error data store 106) to determine whether a record storing the signature and a remediation exists in the collection. Where the ER service identifies a record storing the signature and the remediation within the collection, the ER service transmits a response to the detection service that identifies the remediation. Where the ER service identifies no record storing the signature and the remediation within the collection, the ER services transmits a response to the detection service that includes an acknowledgement. Where the response includes a remediation, the detection service determines 2410 that the error message identified by the signature has been triaged, adds 2418 event data (e.g., the event data 2112 of FIG. 21) to the session data store, and returns to scanning 2402 session data. The event data added 2418 can include an event triage status of complete. Recording of the occurrence of even triaged events can be useful telemetry data that can be analyzed to provide insight as to the number of end users who encountered the error. Where the response includes an acknowledgment, the detection service determines 2410 that the error message identified by the signature has not been triaged.

Where the detection service determines 2410 that the error identified by the signature is not triaged, the detection service adds 2412 event data (e.g., the event data 2112 of FIG. 21) to the session data store. This event data can include a signature generated for the error message, the text included in the error message, the triage status of the error message, a timestamp indicating when the error message was displayed within its corresponding session, and image data including the error message. The event added 2412 event data can further include an update to the overall triage status of the session recording (e.g., incrementing counter of the number of instances of the error within the session recording, updating the number of events triaged or pending triage, etc.).

The detection service determines 2414 whether a trace is actively executing for the session. For instance, the detection service can transmit a message to a diagnostic service (e.g., the diagnostic service 2116 of FIG. 21) to requesting information regarding its operating status. The detection service can receive a response from the diagnostic service and determine from the content of the response whether a trace is actively executing for the session. Where the detection service determines 2414 that a trace is actively executing, the detection service transmits a message (e.g., an inter-process communication mechanism) to the session recording agent to store 2416 diagnostic data within the trace. Where the detection service determines 2414 that a trace is not actively executing, the detection service returns to scanning 2402 session data.

Processes in accordance with the process 2400 enable the system 100 to detect error messages encountered by end users with sessions and present those error for triage, as described herein.

### Session Triage Interface

As described above, in various examples disclosed herein, a session triage interface (e.g., the session triage interface 2114 of FIG. 1) provides a user interface to enable support personnel to triage errors encountered by end users within interactive computing sessions. FIG. 25 illustrates one example of a triage interface screen 2500 provided by one example of the session triage interface. Remediations defined by the support personnel via this session triage interface are stored within error records documenting the error message and its remediation, thereby enabling an error remediation system (e.g., the error remediation system 100 of FIG. 1) to provide the remediation to end users who encounter the error message in the future.

As shown in FIG. 25, the screen 2500 is organized into columns and rows. In some examples, the session triage interface is configured to provide, in the screen 2500, a row for each an error record stored in an error data store (e.g., the error data store 106 of FIG. 1), subject to one or more filters. Types of information stored in or associated with an error record that can be used by the session triage interface to filter the rows provided in the screen 2500 include business organization, region, site, user, number of users effected, and error message to name a few.

As shown in FIG. 25, the screen 2500 includes an app/URL column 2502, an error column 2504, an organization impact column 2506, a user impact column 2508, an instances column 2510, a playback column 2512, a remediation message column 2514, a remediation link column 2516, and an update column 2518. The app/URL column 2502 includes a set of controls that each display an identifier (e.g., a name) of an app/URL that generated one or more error messages. The error column 2504 includes a set of controls that each display an error message encountered by an end user. The organization impact column 2506 includes a set of controls that each display a number of organizations with end users who have encountered the error message. The user impact column 2508 includes a set of controls that each display a number of end users who have encountered the error message. The instances column 2510 includes a set of controls that each display a number of times the error message has been displayed to an end user. The playback column 2512 includes a set of playback controls. In some examples, the session triage interface is configured to initiate playback of a session recording, via a player (e.g., the session recording player 2106 of FIG. 21), in response to receiving a selection of one of the set of playback controls. This session recording can include one or more instances of the error associated with the row of the selected playback control. In at least one of these examples, the session triage interface is configured to, in response to receiving the selection, navigate directly to a point in the session recording associated with the error and at which the error message is displayed.

In certain examples, each playback control of the set of playback controls identifies a session recording that includes the error associated with its row. In at least one of these examples, the session triage interface is configured to identify a “top recording” for each error and store an identifier of the top recording within a property of its associated link control. For example, the session triage interface can identify a top recording as having more instances of the error than other recordings. In another example, the session triage interface can identify a top recording as having more instances per rendered second than other recordings. Other ranking processes can be used to identify a top recording in various examples. For instance, in some examples, the data used to identify the top ranking can be filter to specific time ranges, customers, regions, and/or other dimensions.

In some examples, the remediation message column 2514 includes a set of controls that each are configured to accept text articulating a remediation message to display in conjunction with the error message. The remediation link column 2516 includes a set of controls that each are configured to accept text articulating a hyperlink to display in conjunction with the error message. The hyperlink can, for example, link to an article describing a workaround for the error or a fix for the error. The update column 2518 includes a set of update controls. The session triage interface is configured to update the error record associated with a row in response to receiving a selection of an update control included within the row.

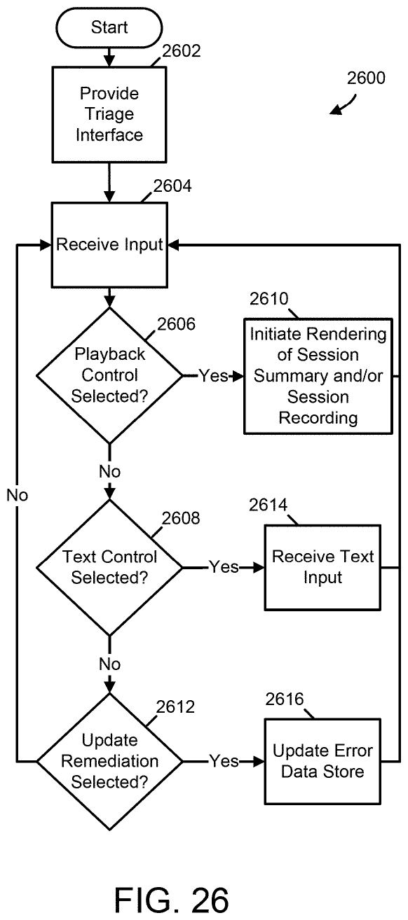

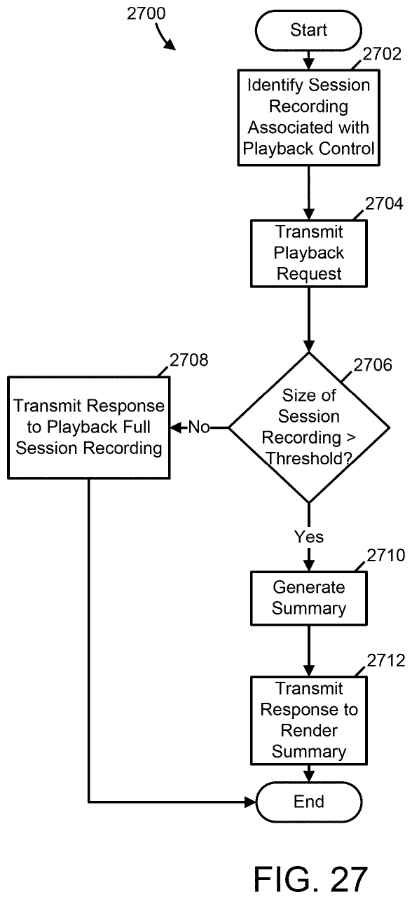

In some examples, a session triage interface is configured to execute a session triage process using the screen 2500. One example of a session triage process 2600 in accordance with these examples is illustrated in FIG. 26. As shown in FIG. 26, the process 2600 starts with the session triage interface providing 2602 a triage interface screen (e.g., the screen 2500 of FIG. 25). The session triage interface receives 2604 input (e.g., a selection of a control of the interface screen). The session triage interface determines 2606 whether a playback control was selected.

Where the session triage interface determines 2606 that a playback control was selected, the session triage interface initiates 2610 a process to playback a session recording associated with the selected playback control and/or a summary of the session recording. FIG. 27 illustrates one example of such a provisioning process 2700 in accordance with some examples. Upon completion of the playback, the session triage interface returns to receiving 2604 input.

As shown in FIG. 27, the session triage interface identifies 2702 the session recording associated with the playback control. For instance, in some examples, the session triage interface accesses a property of the playback control that identifies the session recording associated with the playback control.

The session triage interfaces transmits 2704 a playback request. For instance, in some examples, the session triage interface transmits the playback request to a player (e.g., the session recording player 2106 of FIG. 21). The request can include an identifier of the session recording and an indicator that either the full session recording or a summary of the session recording is acceptable. In response to receiving the playback request, the player forwards the playback request to a session recording server (e.g., the session recording server 2104 of FIG. 21). The session recording server parses the request and determines that either the full session recording or a summary is acceptable.

The session recording server provides the request to a summarization service (e.g., the summarization service 2118 of FIG. 21). The summarization service determines 2706 whether the size of the full session recording transgress a user or system configurable threshold value. This threshold value can be included in the playback request, although this is not a requirement. Where the summarization service determines 2706 that the size of the full session recording does not transgress the threshold value, the summarization service instructs the session recording server to transmit 2708 a response to the player to initiate playback of the full session recording. The session recording server transmits the response to the player. The player receives and parses the response, accesses the full session recording as stored in a session data store (e.g., the session data store 2108 of FIG. 21), and plays the full session recording. In some examples, the player automatically navigates to a point in the full session recording associated with the error. Alternatively or additionally, the player can annotate the full session recording with event data (e.g., the event data 2112 of FIG. 21) at corresponding temporal locations within the full recording session.

Where the session recording server determines 2706 that the size of the full session recording transgresses the threshold value, the session recording server generates 2710 a summary by, for example, executing a summarization service (e.g., the summarization service 2118 of FIG. 21). The summarization service receives an identifier of the session recording from the session recording server and executes a process to summarize the identified session recording. FIG. 28 illustrates one example of such a summarization process 2800.

As shown in FIG. 28, the summarization process starts with the summarization service identifying 2802 the next event within the identified session recording. In some examples, the summarization service identifies the next event by accessing the event data associated with the identified session recording. In these examples, the event data associated with the identified session recording specifies events that occurred therein. As described above, the event data can include data descriptive of errors and other events of interest to support personnel. This data can include temporal location (e.g., a timestamp) of the events.

The summarization service generates 2804 a snippet including a subset of session data from the full session recording that depicts the identified session event. For example, the snippet can be a precise point in the session data (e.g., image data depicting an error message or a screenshot that includes the error message). In other examples, the snippet is a subset of the session data that, when rendered, spans a user or system configurable interval within the full session recording. The basis of the internal can vary between examples. For instance, in some examples, the interval is temporal (e.g., spans a period of time between 1 and 5 seconds before and/or after occurrence of the event). Additionally or alternatively, the interval can based on user interaction with the client device (e.g., spans a period between 1 and 3 interactions before and/or after occurrence of the event). After the snippet is generated 2804, the summarization service adds it to the summary of the full session recording.

The summarization service determines 2806 whether the identified event is the last event associated with the session recording. Where the summarization service determines that the identified event is not the last event, the summarization service returns to identify 2802 the next session event. Where the summarization service determines that the identified event is the last event, the summarization service closes the summary and terminates the process 2800.

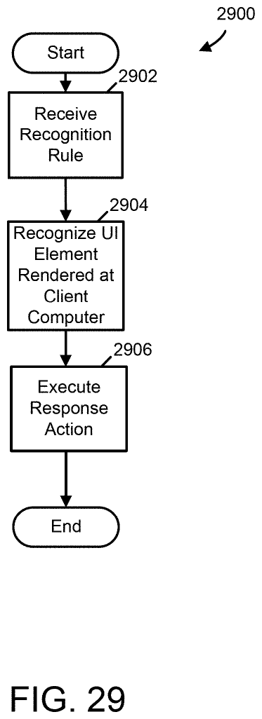

FIG. 29 is a flow diagram of a process 2900 for recognizing and responding to UI elements in accordance with an example of the present disclosure. In various examples, process 2900 may be executed by a client device and/or by a rule processor, CV processor, and/or action handler implemented by a client device. As shown in FIG. 29, the recognizing and responding process starts with the client device receiving 2902 a UI element recognition rule comprising one or more UI element specifications and a response action. For example, the recognition rule may be in the form of a structured tag or a specialized language, such as FPML, VPML, Frame Processing Query Language, or Video Processing Query Language, as described above.

In an example, the client device can receive 2902 the recognition rule from a workspace server. The workspace server can be configured to receive configuration input specifying the UI element recognition rule, for example from an administrator. The workspace server can be configured to send the recognition rule to the client device.

Next, the client device can recognize 2904, based on the one or more UI element specifications, a UI element. The client device can use CV and/or ML methods to recognize the UI element based on the UI element specifications, as described in FIGS. 5-7 above. The client device can also use timing information, mouse clicks, key presses, or other user events, hook messages and/or UI automation messages from the client device's OS, and/or other methods to recognize a UI element and/or to detect the rule condition, as disclosed herein above.

Finally, the client device can execute 2906 the response action. In various examples, the response action could include displaying a remediation message or link, as in the examples of FIGS. 19 and 20, notifying an administrator, recording information and/or video about a user session, and/or taking another response action.

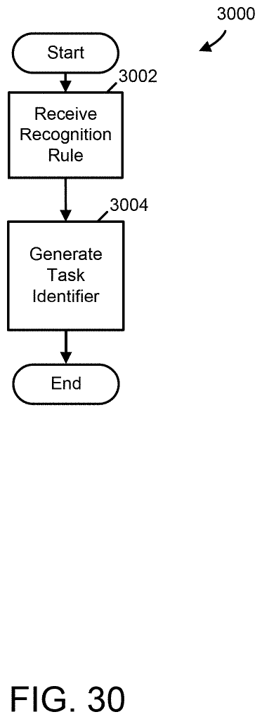

FIG. 30 is a flow diagram of a process 3000 for processing rules while recognizing and responding to UI elements in accordance with an example of the present disclosure. In this example, process 3000 may provide additional details of process 2900 for recognizing and responding to UI elements in FIG. 29. In various examples, process 3000 may be executed by a client device and/or by a rule processor implemented by a client device.

As shown in FIG. 30, the recognizing and responding process starts with the client device and/or the rule processor receiving 3002 a UI element recognition rule comprising one or more UI element specifications and a response action. For example, the recognition rule may be in the form of a structured tag or a specialized language, such as FPML, Frame Processing Query Language, VPML, or Video Processing Query Language, as described above.

In an example, the client device and/or the rule processor can receive 3002 the recognition rule from a workspace server. The workspace server can be configured to receive configuration input specifying the UI element recognition rule. For example, an administrator may use structured tags or a language to specify UI element recognition rules and related policies, such as FPML, Frame Processing Query Language, VPML, or Video Processing Query Language. The administrator may enter or send the rules and policies as input to the workspace server. The workspace server can be configured to send the recognition rules and policies to the client device.

For example, an FPML tag can specify a condition to match (for example, using a “Dialog” and/or another UI element tag) and an action to take in response to a match (a “MatchFound” tag). In particular, the match condition can include a UI element type, title, text, buttons, colors, controls, and the like. When interpreting the FPML rule and carrying out the match, the client device can make use of a CV model that is designed in advance and/or an ML model that is trained in advance. Accordingly, using the disclosed system and methods, the administrator can develop the FPML tags and configure the rule without requiring detailed knowledge of the ML and/or CV models.

Next, the client device and/or the rule processor can generate 3004 a task ID corresponding to the received recognition rule. The client device and/or the rule processor can send the task ID, for example to a CV processor and/or an action handler implemented by the client device. In some examples, the client device can use the task ID to organize and track the recognition rule.

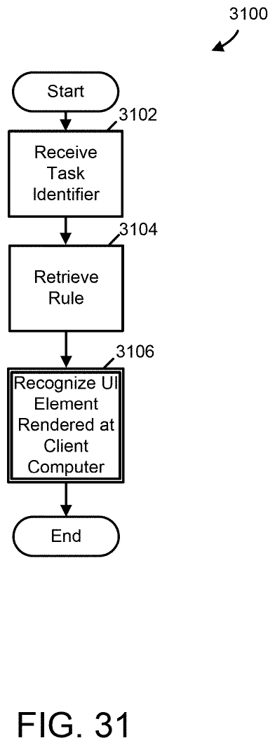

FIG. 31 is a flow diagram of a process 3100 for processing CV while recognizing and responding to UI elements in accordance with an example of the present disclosure. In this example, process 3100 may provide additional details of process 2900 for recognizing and responding to UI elements in FIG. 29. In various examples, process 3100 may be executed by a client device and/or by a CV processor implemented by a client device.

As shown in FIG. 31, processing CV starts with the client device and/or the CV processor receiving 3102 a task ID, for example from a rule processor implemented by the client device.

Next, the CV processor or the client device can retrieve 3104 a rule corresponding to the received task ID. For example, the system can retrieve 3104 the rule so as to determine the one or more UI element specifications to recognize as part of a task corresponding to the task ID. In some examples, the system may directly retrieve the rule, for example by using the task ID and/or the hash or another received identifier as an array index to retrieve the correct rule, e.g. from an array. Alternatively, in some examples, the retrieved rule may be a candidate rule, which can include a candidate task ID to be compared to the received task ID. In another example, the system may simply retrieve a candidate task ID, array index, hash, or other identifier, which the system can retrieve before deciding whether to retrieve the entire rule contents.

In some examples, the retrieved rule may include a structured tag or a specialized language encoding the rule, such as FPML, Frame Processing Query Language, VPML, or Video Processing Query Language. In various examples, the rule may be retrieved from memory, storage, from a server such as the workspace server, or from any other source.

Alternatively, in some examples the CV processor can receive part or all of the rule (e.g., part or all of an FPML tag) from the rule processor. For example, the CV processor may receive the rule condition, or the entire rule. The CV processor can then interpret the received rule or rule condition in order to determine the one or more UI element specifications.

Next, the CV processor can recognize 3106, based on the one or more UI element specifications, a UI element. The CV processor can use CV and/or ML methods to recognize the UI element based on the UI element specifications, as described in FIGS. 5-7 above. The CV processor can also use timing information, mouse clicks, key presses, or other user events, hook messages and/or UI automation messages from the client device's OS and/or a local process on the client device (such as a workspace app), and/or other methods to recognize a UI element and/or to detect the rule condition, as disclosed herein above. In some examples, the CV processor can generate a hash value for UI elements, and may use the hash value to determine whether the rendered UI element matches the rule condition. In an example, the CV processor can send the hash value to the workspace server, which can track a number of instances of the hash value. In some examples, the CV processor can also use information about a total number of instances of a UI element across user sessions, a number of affected individual users, and/or a number of affected user sessions, when determining whether the rule condition has been satisfied.

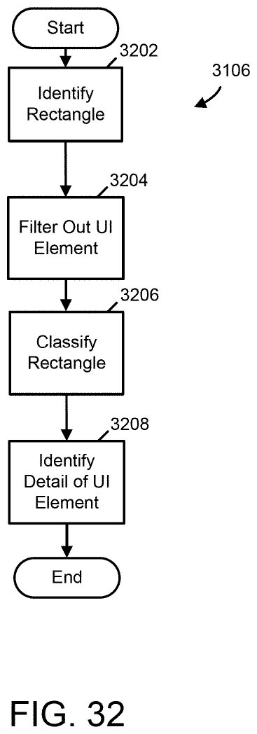

FIG. 32 is a flow diagram showing details of process 3106 for recognizing UI elements in accordance with an example of the present disclosure. In this example, process 3106 may provide additional details of step 3106 of process 3100 for processing CV in FIG. 31. In various examples, process 3106 may be executed by a client device, by a CV processor, and/or by a CV model implemented by a client device.

As shown, processing CV can start with the client device and/or the CV processor identifying 3202 one or more rectangles comprising windows, buttons, title bars, or other software UI elements or parts thereof. For example, the CV model can first execute edge detection techniques (such as a Sobel filter, a Canny edge detector, a Deriche edge detector, and the like) to identify the rectangles.

Next, the CV model may filter out 3204 extraneous or irrelevant UI objects. For example, the CV model can filter out 3204 UI elements unlikely to belong to a dialog or menu item group. The system may make use of information about typical areas of various UI elements, for example it may use the fact that dialogs and menu item groups generally have larger areas than other typical software UI elements such as text, buttons, etc. Thus, to filter out irrelevant objects, the system can identify edges belonging to a rectangle or square, calculate the area of the rectangle or square, and compare the area to a threshold value. In another example, the CV model may determine contours and compute contour areas.

Next, the CV model can classify identified shapes 3206, such as rectangles or squares, by a guided heuristics method. For example, the CV model can identify a menu item group, at least in part because it contains equally spaced menu items and/or based on some menu items including an icon. In some examples, the CV model can synergistically use cues to recognize individual UI elements, such as menu items, and also to recognize larger cumulative UI elements, such as menu item groupings, and these two levels of classification can mutually reinforce each other. In another example, the CV model can use an icon, buttons, or a title bar's color to classify a dialog.

Finally, the CV model may identify details 3208 for the UI element. For example, the system can scan and/or can apply OCR to the upper area of a dialog to identify a title bar 512. The CV model can also identify buttons as smaller rectangles and/or apply OCR to identify button text. In another example, the CV model can identify a selected UI element, such as a menu item, by comparing its color attributes to nearby elements. The CV processor can also execute an ML model to recognize UI elements and/or features thereof.

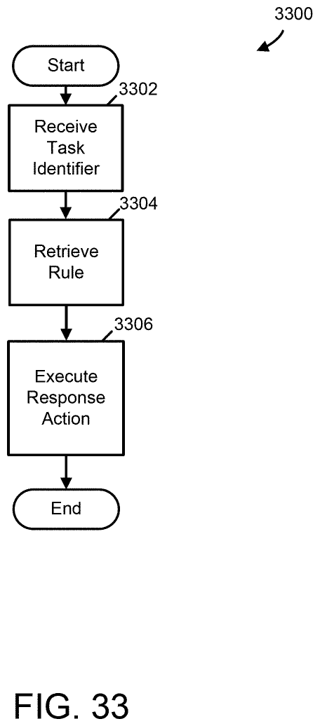

FIG. 33 is a flow diagram of a process 3300 for handling actions while recognizing and responding to UI elements in accordance with an example of the present disclosure. In this example, process 3300 may provide additional details of process 2900 for recognizing and responding to UI elements in FIG. 29. In various examples, process 3300 may be executed by a client device and/or by an action handler implemented by a client device.

As shown in FIG. 33, the process for handling actions starts with the client device and/or the action handler optionally receiving 3302 a task ID, for example from a rule processor implemented by the client device.

Next, the action handler or the client device can retrieve 3304 a rule corresponding to the received task ID. For example, the system can retrieve 3304 the rule so as to determine the response action to execute as part of a task corresponding to the task ID. In some examples, the system may directly retrieve the rule, for example by using the task ID and/or the hash or another received identifier as an array index to retrieve the correct rule, e.g. from an array. Alternatively, in some examples, the retrieved rule may be a candidate rule, which can include a candidate task ID to be compared to the received task ID. In another example, the system may simply retrieve a candidate task ID, array index, hash, or other identifier, which the system can retrieve before deciding whether to retrieve the entire rule contents.

In some examples, the retrieved rule may include a structured tag or a specialized language encoding the rule, such as FPML, Frame Processing Query Language, VPML, or Video Processing Query Language. In various examples, the rule may be retrieved from memory, storage, from a server such as the workspace server, or from any other source.

Alternatively, in some examples the action handler or the client device can receive part or all of the rule (e.g., part or all of the FPML tag) from the rule processor. For example, the action handler may receive the response action, or the entire rule. The action handler can then interpret the received rule or response action in order to determine the response action corresponding to the rule condition that has been satisfied.

Next, the client device and/or the action handler can execute 3306 the response action. In various examples, the response action could include displaying a remediation message or link, as in the examples of FIGS. 19 and 20, notifying an administrator, recording information and/or video about a user session, and/or taking another response action.

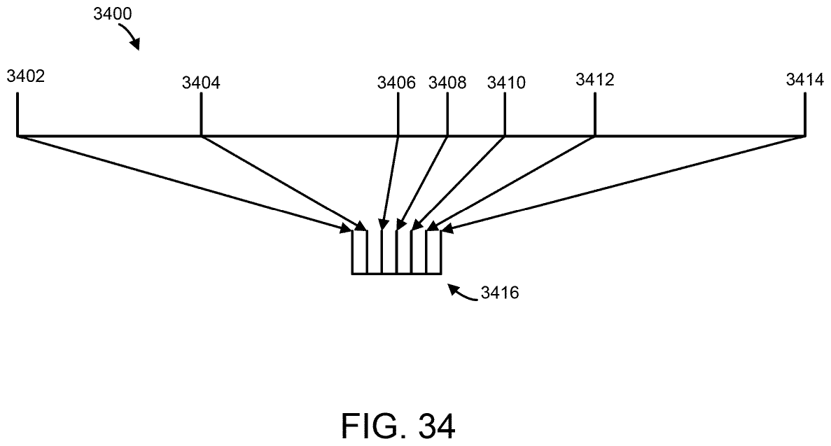

Processes in accordance with the process 2800 enable a session recording server to create succinct summaries of full session recording that can be easily transmitted to remote players for subsequent processing. FIG. 34 illustrates an example of both a full session recording 3400 and a summary 3416 as processed by the process 2800. The full session recording 3400 includes several events 3402-3414. These events may include session recording starts and ends (e.g., events 3402 and 3414), updates of registry values of the client device (e.g., event 3404), and error messages (e.g., events 3406-3412). As shown in FIG. 34, after the full session recording 3400 is processed according to the process 2800, the summary 3416 includes snippets of each of the event 3402-3414 but consists of much less session data.

Returning to the process 2700, the summarization service instructs the session recording server to transmit 2712 a response to the player to initiate playback of the summary. The session recording server transmits the response to the player. The player receives and parses the response, accesses the summary as stored in the session data store, and plays the summary. In some examples, the player annotates the summary with event data at corresponding temporal locations within the summary.

Processes in accordance with the process 2700 enable a session triage system to provide support personnel with full session recordings and/or streamlined session summaries that facilitate triage of error messages, even where network bandwidth within the system is low.

Returning to the process 2600, where the session triage interface determines 2606 that a playback control was not selected via the received input, the session triage interface determines 2608 whether a text control (e.g., a control from either column 2514 or column 2516) was selected.

Where the session triage interface determines 2608 that a text control was selected, the session triage interface receives 2614 text input and stores that input in the selected control. Where the session triage interface determines 2608 that a text control was not selected, the session triage interface determines 2612 whether an update control (e.g. a control from column 2512) was selected.

Where the session triage interface determines 2612 that an update control was not selected, the session triage interface returns to receiving 2604 input. Where the session triage interface determines 2612 that an update control was selected, the session triage interface updates 2616 an error record associated with the row including the selected update control. In executing the update, the session triage interface replaces the values in the error record with the contents of the text controls in the selected row. Further, in some examples, in executing the update, the session triage interface updates the triage status to complete for each event within the session data store having the same signature as the signature in the error record. In these examples, the session triage interface further updates the triage status to complete for each session associated with no untriaged events.

The processes disclosed herein each depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

1. A client computer system configured to recognize and respond to user interface (UI) elements, the client computer system comprising:
a memory; and
at least one processor coupled to the memory and configured to:
receive a recognition rule comprising one or more UI element specifications and a response action from a server;
generate a task identifier corresponding to the received recognition rule;
associate the task identifier with the recognition rule;
recognize, based on the one or more UI element specifications of the recognition rule and the task identifier, a UI element rendered at the client computer system; and
execute, in response to recognition of the UI element, the response action of the recognition rule based on the task identifier.

2. The client computer system of claim 1, wherein to recognize the UI element based on the recognition rule further comprises to execute a CV process.

3. The client computer system of claim 2, wherein to execute the CV process further comprises one or more of:
to identify a rectangle;
to filter out a user interface (UI) element;
to identify a detail of a dialog or menu item group; or
to classify a rectangle using a guided heuristic.

4. The client computer system of claim 1, wherein to recognize the UI element based on the recognition rule further comprises to execute a machine learning (ML) process.

5. The client computer system of claim 1, wherein the at least one processor is configured to:
generate a numerical hash value by executing a hash function on one or more characteristics of the rendered UI element;
send the numerical hash value to the server; and
further comprising the server, wherein the server is configured to track a number of instances of the numerical hash value.

6. The client computer system of claim 1, wherein the one or more UI element specifications describe one or more of:
a size or shape of a dialog or window;
text of a dialog or window;
an icon or image of a dialog or window;
a progress bar or scroll bar of a dialog or window;
a button or other control of a dialog or window;
a menu item; or
a number of instances or affected users associated with the UI element.

7. The client computer system of claim 1, wherein the recognition rule comprises a structured recognition rule tag including:
one or more structured UI element specification tags encoding the one or more UI element specifications; and
a structured response action tag encoding the response action.

8. The client computer system of claim 1, wherein the UI element rendered at the client computer system comprises one or more of:
an error notification;
a password entry field;
a delay notifier;
a pop-up menu item;
personal information; or
a personal message.

9. A method of recognizing and responding to user interface (UI) elements, the method comprising:
receiving a recognition rule comprising one or more UI element specifications and a response action from a server;
recognizing, based on the one or more UI element specifications, a UI element rendered at the client computer; and
executing, in response to the recognition of the UI element, the response action of the received recognition rule.

10. The method of claim 9, further comprising executing a CV process to recognize the UI element based on the recognition rule, wherein the CV process comprises one or more of:
identifying a rectangle;
filtering out a user interface (UI) element;
identifying a detail of a dialog or menu item group; or
classifying a rectangle using a guided heuristic.

11. The method of claim 9, further comprising executing a machine learning (ML) process to recognize the UI element based on the recognition rule.

12. The method of claim 9, further comprising:
generating a numerical hash value by executing a hash function on one or more characteristics of the rendered UI element;
sending the numerical hash value to the server; and
tracking, by the server, a number of instances of the numerical hash value.

13. The method of claim 9, wherein the one or more UI element specifications describe one or more of:
a size or shape of a dialog or window;
text of a dialog or window;
an icon or image of a dialog or window;
a progress bar or scroll bar of a dialog or window;
a button or other control of a dialog or window;
a menu item; or
a number of instances or affected users associated with the UI element.

14. The method of claim 9, wherein the recognition rule comprises a structured recognition rule tag including:
one or more structured UI element specification tags encoding the one or more UI element specifications; and
a structured response action tag encoding the response action.

15. A non-transitory computer readable medium storing executable sequences of instructions to recognize and respond to user interface (UI) elements, the sequences of instructions comprising instructions to:
receive a recognition rule comprising one or more UI element specifications and a response action from a server;
generate a task identifier corresponding to the received recognition rule;
associate the task identifier with the recognition rule;
recognize, based on the one or more UI element specifications of the recognition rule and the task identifier, a UI element rendered at the client computer system; and
execute, in response to the recognition of the UI element, the response action of the recognition rule based on the task identifier.

16. The non-transitory computer readable medium of claim 15, wherein to recognize the UI element comprises to execute a CV process for one or more of:
to identify a rectangle;
to filter out a user interface (UI) element;
to identify a detail of a dialog or menu item group; or
to classify a rectangle using a guided heuristic.

17. The non-transitory computer readable medium of claim 15, wherein the instructions further comprise instructions to:
generate a numerical hash value by executing a hash function on one or more characteristics of the rendered UI element; and
send the numerical hash value to the server, the server being configured to track a number of instances of the numerical hash value.

18. The non-transitory computer readable medium of claim 15, wherein the one or more UI element specifications describe one or more of:
a size or shape of a dialog or window;
text of a dialog or window;
an icon or image of a dialog or window;
a progress bar or scroll bar of a dialog or window;
a button or other control of a dialog or window;
a menu item; or
a number of instances or affected users associated with the UI element.

19. The non-transitory computer readable medium of claim 15, wherein to recognize the UI element comprises to recognize one or more of:
an error notification;
a password entry field;
a delay notifier;
a pop-up menu item;
personal information; or
a personal message.

20. The non-transitory computer readable medium of claim 15, wherein the recognition rule comprises a structured recognition rule tag including:
one or more structured UI element specification tags encoding the one or more UI element specifications; and
a structured response action tag encoding the response action.
